(19) United States
(12) Patent Application Publication
(10) Pub. No.: US 2019/0341617 A1
(43) Pub. Date: Nov. 7, 2019

(54) ANODE MATERIALS FOR LITHIUM ION BATTERIES

(71) Applicant: Cambridge Enterprise Limited, Cambridge (GB)

(72) Inventors: Adam Meyer Boies, Cambridge (GB); Michael Franciscus De Volder, Cambridge (GB); Chandramohan George, Delft (NL); Jean Leclerc De La Verpilliere, Cambridge (GB)

(21) Appl. No.: 16/348,453

(22) PCT Filed: Nov. 9, 2017
(86) PCT No.: PCT/EP2017/078732

§ 371 Date: May 8, 2019

(30) Foreign Application Priority Data
Nov. 9, 2016 (GB) 1618934.2

(51) Int. Cl. H01M 4/62; H01M 10/0525; H01M 4/525; H01M 4/36

(52) U.S. Cl. CPC H01M 4/625; H01M 10/0525; H01M 2004/027; H01M 4/366; H01M 4/525

(57) ABSTRACT

An anode active material for a lithium ion battery, or other electrochemical device, is disclosed. The material comprises particles of Fe Al Li O, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe Al Li O. Also disclosed are nanostructures in which the particles are core particles, with carbon nanotubes anchored at one end to the core particles. A method for the manufacture of such nanostructures is described, along with a method for processing such nanostructures for a lithium ion battery.

The work leading to this invention has received funding from the European Research Council under the European Union's Seventh Framework Programme (FP7/2007-2013)/ERC grant agreement number 337739.

### BACKGROUND TO THE INVENTION

### Field of the Invention

The present invention relates to materials and methods for their manufacture and processing, the materials being of particular (but not necessarily exclusive) interest as anode materials for lithium ion batteries. The invention also relates to lithium ion batteries and methods for their operation.

### Related Art

As background to this technical field, we refer in particular to the review provided in Glaize & Genies (2013). Some parts of that disclosure are set out below, to provide the context for the disclosure of the present invention.

Lithium ion (Li-ion) batteries are a commonly used type of rechargeable battery with a global market estimated at $11 bn in 2010 and predicted to grow to $50 bn by 2020. This huge market is divided between a number of applications:
Hybrid vehicles, Plug-in Hybrid Electrical Vehicles (PHEVs), and all Electric Vehicles (Evs)
Power electronics, which includes tools, robotics, electrical bicycles, wheelchairs
Consumer electronics, which includes mobile phones and tablets, connected objects
Storage for autonomous and grid-connected energy systems
Aeronautics and space, where batteries are used to provide an autonomous onboard grid
Specialists batteries, for instance microfabricated/3d-printed flexible batteries for
Prosthetic implants.

The main outlet for Li-ion batteries is consumer electronics, both in terms of number of units sold and turnover. Electric vehicles, if they develop as they are predicted to, will ultimately represent the dominant market.

Each of these applications have very different requirements in terms of battery performances. For instance electrical vehicle batteries need to be able to provide a large electric current without degrading to sustain vehicle acceleration phases, whereas consumer electronics batteries would rather benefit from the capability to be flexed, folded, or stretched. Ultimately these specific requirements lead to different technological choices in terms of battery design, especially with regards to the choice of the electrochemically active materials that store the lithium ions during charge and discharge. For this reason, one technology—e.g. silicon anodes—cannot dominate the entire market. Battery technologies rather need to be examined in the light of how well they perform on a number of metrics, the combination of which will ultimately give one technology a competitive advantage for one specific application. Examples are given in Table 1. These metrics are described below.

A typical lithium-ion battery is composed of multiple cells connected in series or in parallel. Each individual cell is usually composed of an anode (negative polarity electrode) and a cathode (positive polarity electrode), separated by a porous, electrically insulating membrane (called a separator), immersed into a liquid (called an electrolyte) enabling lithium ions transport.

In most systems, the electrodes are composed of an electrochemically active material—meaning that it is able to chemically react with lithium ions to store and release them reversibly in a controlled manner—mixed with an electrically conductive additive (such as graphitic carbon) and a polymeric binder. This slurry is coated as a thin film on a current collector (typically a thin foil of copper or aluminium, or a carbon nanotube mat in emerging applications), thus forming the electrode.

In the known Li ion battery technology, the low theoretical capacity (about 370 mA g⁻¹) of graphite anodes is a serious impediment to its application in high-power electronics, automotive and industry. Among a wide range of potential alternatives proposed recently, Si, MₓS_{y} and FeₓO_{y} are the main contenders to replace graphite as the active material of choice. Si has about 10 times more theoretical capacity than graphite but its dramatic volume expansion (up to about 400%) severely limits high-power applications. Although this problem can be partially tackled by carbon coating [Liu et al (2014)], implementation of these in large scale is still problematic. Similarly, metal sulphide (MₓS_{y}) electrodes, despite their high theoretical capacity not only suffer from volume expansion but dissolution of polysulfides that form during charge/discharge [Liang et al (2015)] in battery electrolytes. On the other hand, FeₓO_{y}-nanocarbon [Tuek et al (2014)] has now emerged as a promising anode material platform because of its higher (600-1000 mAh/g, or 600-800 mAh/g sustained) capacity than graphite, good capacity retention at high rates, environmental-benignity, high corrosion resistance, low-cost, non-flammability and high-safety. However, FeₓO_{y} based anodes have some drawbacks, operating via conversion or conversion alloying, as explained in Loeffler et al (2015).

Ren et al (2015) reported the formation of a composite material of carbon fibre with CoFe₂O₄ binary metal oxide particles. The performance of this material as an anode material for a lithium ion battery was investigated. After 20 cycles the capacity reported in Ren et al (2015) is 400 mAh/g. Further improvements in the performance of candidate anode materials would be desirable.

Tuek et al (2014) and Ren et al (2015) are two examples of conversion batteries, meaning that the chemical mechanisms leading to lithium ions storage and release is a conversion reaction. The conversion mechanism can be generally described as follows:

TMₓO_{y}+z e⁻+zLi⁺->xTM⁽⁰⁾+Li_{z}O_{y}

where TM is a transition metal and TM⁽⁰⁾ refers to is elemental form. Upon battery charging, lithium ions diffuse and react into these materials, and nanoscale metallic domains of TM⁽⁰⁾ are formed, embedded in an amorphous matrix of Li_{z}O_{y}. The reaction is reversed during battery discharge.

Conversion anodes have recently been branded as the next generation anodes [Loeffler et al (2015)]. As explained in Loeffler et al (2015), an appealing feature of conversion materials is their ability to store more equivalents of lithium (two to eight per unit formula of the starting material) than any insertion compound (up to two), resulting in substantially higher specific capacities. However, conversion materials exhibit a series of severe drawbacks which necessarily need to be overcome before they can be seriously considered for commercial applications [Cabana et al (2010)]. These drawbacks are also explained in Loeffler et al (2015). The conversion reaction inherently causes a massive structural reorganisation, which potentially leads to a loss of electrical contact and electrode pulverisation. Moreover, conversion materials suffer from a very high reactivity towards commonly used electrolytes and a marked (dis-)charge voltage hysteresis, considerably affecting the energy storage efficiency of such electrodes. The elevated operational potentials of many conversion materials also limit the achievable energy density and the large first-cycle irreversible capacity is considered to be unacceptable for practical applications.

Electrode pulverisation refers to the loss of electrode mechanical integrity after charge and discharge cycling. Upon active material lithiation and delithiation, the active material swells and contracts, creating internal stresses that can ultimately lead to structural damage.

EP-A-0825153 discloses cathode active materials for Li ion batteries. In one embodiment, the cathode active material is Li_{0.95}Fe_{0.95}A_{0.05}O₂.

### SUMMARY OF THE INVENTION

The present inventors have realised that FeₓO_{y}-nanocarbon structures provide a particularly advantageous basis for the development of new anode materials for lithium ion batteries. The invention has been devised based on a realisation that a known nanostructured material can be used as an anode material for lithium ion batteries. Further developments of the invention are based on additional insights into modifications of the material, to form new materials, and the development of additional uses for such materials.

U.S. Pat. No. 8,628,747 discloses a CVD process for the bulk production of carbon nanotubes (CNTs). First, metal composite Fe-Ai particles are generated by spray pyrolysis by spraying a solution consisting of water, iron nitrate and aluminium nitrate and subsequently carrying out pyrolytic conversion of the free floating metal nitrate particles by heating in a furnace at about 1000° C. in hydrogen. The aerosol (free floating) metal composite particles are then reacted with a suitable hydrocarbon compound (e.g. acetylene) in a suitable thermal reactor, with an inert carrier gas and hydrogen, at about 750° C., to facilitate growth of CNTs on the surface of the metal composite particles. The present inventors consider that having the particles free-floating here means that very large flowrates of carrier gas/H₂/precursor gas need to be used in order to maintain the particles suspended/aerosolised. This is expensive and disadvantageously limits residence time in the reactor.

The resultant nanostructures have a core particle of Fe-Al-O with an array of CNTs anchored at the surface of the core particle. Due to their particular morphology, these nanostructures are referred to in the academic literature and in U.S. Pat. No. 8,628,747 as having a “sea urchin” structure.

To the knowledge of the inventors, the proposed applications of these Fe-Al-O/CNT sea urchin nanostructures has been limited so far to the bulk production of carbon nanotubes [Kim et al (2011)], nanofluid coolants additives [Han et al (2007)], solar cells [Park et al. (2010)] and thermite materials [Kim et al (2014)].

The present invention has been devised in order to address at least one of the problems identified above. Preferably, the present invention reduces, ameliorates, avoids or overcomes at least one of the above problems.

Accordingly, in a first preferred aspect, the present invention provides an electrochemical device comprising an anode, cathode and electrolyte, wherein the anode and/or cathode comprises an active material comprising core particles and carbon nanotubes, the core particles are electrochemically active in the device and the carbon nanotubes are anchored on the core particles to form nanostructures.

In a second preferred aspect, the present invention provides an anode active material for a lithium ion battery, the anode active material comprising particles of Fe-Al-Li-O, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe-Al-Li-O.

In a third preferred aspect, the present invention provides a lithium ion battery comprising an anode, cathode and electrolyte, wherein, either:

(i) the lithium ion battery comprises an electrochemical device according to the first aspect; or
(ii) the anode comprises an anode active material according to the second aspect.

In a fourth preferred aspect, the present invention provides a use of an anode active material according to the second aspect in an anode in conjunction with a cathode and an electrolyte in a lithium ion battery for charging and discharging of the lithium ion battery.

In a fifth preferred aspect, the present invention provides a method for processing an anode active material for a lithium ion battery, the method including:
providing a material comprising particles of Fe-Al-Li-O, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe-Al-Li-O;
diffusing lithium ions into the particles thereby to form lithium oxide and metallic iron via a conversion reaction and/or a conversion alloying reaction.

In a sixth preferred aspect, the present invention provides a layer of material comprising particles of Fe-Al-Li-O and carbon nanotubes, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe-Al-Li-O, wherein the particles of Fe-Al-Li-O are core particles and the carbon nanotubes are anchored at one end on the core particles to form nanostructures.

In a seventh preferred aspect, the present invention provides a method for the manufacture of nanostructures comprising core particles and carbon nanotubes, wherein the carbon nanotubes are anchored at one end on the core particles, the method comprising:

providing a solution of at least one metal salt and a combustible component; spray drying the solution to form precursor particles comprising the at least one metal salt and the combustible component;
subjecting the precursor particles to combustion heat treatment to combust the combustible component and to convert the at least one metal salt to metal oxide, metal, or a mixture of metal and metal oxide, thereby forming core particles; and subjecting the core particles to carbon nanotube growth conditions, to grow carbon nanotubes from the core particles, thereby forming the nanostructures.

The first, second, third, fourth, fifth, sixth and/or seventh aspect of the invention may have any one or, to the extent that they are compatible, any combination of the following optional features.

Preferably, the carbon nanotubes are grown from the core particles. The carbon nanotubes may be, for example, covalently bonded to the core. The core particles may have protrusions extending from the core particle, the protrusions being formed integrally with the core particle, wherein respective protrusions protrude into respective carbon nanotubes to anchor the carbon nanotubes with respect to the core. Note that this arrangement differs from the situation where a core particle has heterogeneous catalyst particles disposed at the surface of the core particle and the CNTs grow from those catalyst particles. In that case, the catalyst particles are not integral with the core. The difference between these situations can be considered in relation to the electrochemically active material. In the preferred embodiment of the present invention, the core particle is formed of the electrochemically active material, including the integral protrusion.

Preferably, Al is present in an amount of at least 5 wt %. Furthermore, preferably, Al is present in an amount of at most 70 wt %. The amount of Al is chosen in order to promote the formation of a suitable array of CNTs at the core particle surface, as explained in more detail below.

Preferably, Li is present in the particles of Fe-Al-Li-O in an amount of at least 0.1 wt %. In the context of Li ion batteries, such a state would exist, for example, where the anode active material has been used for charging and/or discharging a Li ion battery. Furthermore, in view of the conversion reaction and/or conversion alloying that takes place during charging, the core particles preferably contain lithium oxide and metallic iron.

The anode active material may further comprise an electrically conductive additive. The electrically conductive additive preferably comprises elemental carbon. For example, the electrically conductive additive may comprise carbon nanotubes. In a particularly preferred embodiment, the particles of Fe-Al-Li-O are core particles and the carbon nanotubes are anchored at one end on the core particles to form nanostructures. As can be noted on careful inspection of the nanostructures, preferably the carbon nanotubes are grown from the core.

The core particles may have, on average, at least 10¹¹ carbon nanotubes per m² anchored on the core particles. The core particles may have, on average, at most 10¹⁷ carbon nanotubes per m² anchored on the core particles. These values may be determined by SEM inspection of the nanostructures, by assessing the diameter of the core particle to determine the surface area of the core particle (not including porosity, where present) and counting the anchored carbon nanotubes.

The anode active material may comprise at least 0.1 wt % by weight of carbon nanotubes, expressed in terms of the total weight of the core particles and the carbon nanotubes. The anode active material may comprises not more than 99% by weight of carbon nanotubes, expressed in terms of the total weight of the core particles and the carbon nanotubes. The benefits of the carbon nanotube content for the material are explained in more detail below.

The particles may have a diameter in the range 30 nm to 50 μm. Within this range, it is found that the material provides suitable performance in particular as an active material for Li ion batteries. It is further preferable that the particles have a diameter in the range 30 nm to 10 μm.

The particles may include a matrix of amorphous Al-Fe-O. Furthermore, Al-Fe-O crystallites may be embedded in the matrix of amorphous Al-Fe-O. The Al-Fe-O crystallites may comprise a solid solution of hercynite into magnetite. Where carbon nanotubes are anchored to the core particles, it is preferred that the carbon nanotubes are attached to the core particles at Al-Fe-O crystallites. It is considered by the inventors, without wishing to be bound by theory, that the Al-Fe-O crystallites provide nucleation and growth sites for the carbon nanotubes.

Preferably, the anode active material has an average discharge potential, when measured against Li/Li+ in a half cell, of at most 1.8 V.

Preferably, during the use of the material in the third aspect of the invention, during charging, lithium ions diffuse into the particles, and a conversion reaction and/or a conversion alloying reaction takes place in which lithium oxide and metallic iron are formed.

Capacity, rate capability, cyclability (i.e. durability), safety, cost can potentially be improved by the use of conversion anodes. However, as stated above, fundamental problems have so far impeded the use of conversion anodes in commercial systems. The present inventors consider that the preferred embodiments of the present invention address these problems, as now explained.

One problem which has been considered to be present for conversion anodes is loss of electrical contacts and electrode pulverisation. The present inventors, without wishing to be bound by theory, consider that the sea-urchin structure promotes the so-called buffer effect of carbon nanotubes. This means that the stiff carbon nanotubes act as a structural reinforcement helping to preserve the integrity of active material particles. Also the nature of the carbon nanotube network resulting from the sea-urchin structures, each active core being essentially a node of the network, limits the proportion of active material that may become inaccessible to electrons or lithium-ions during battery operation. Furthermore, the volume expansion/structural changes occurring to the active material seem to be fundamentally mitigated by the use of the Al—Fe—O alloy, limiting electrode pulverisation for both the Al-Fe-O particles and the full Al-Fe-O sea-urchins.

Another problem which has been considered to be present for conversion anodes is a perceived high reactivity towards commonly used electrolytes. However, in the preferred embodiments of the present invention it is considered that the Al—Fe—O alloy forms a stable solid electrolyte interphase (SEI) with the electrolyte, ensuring stable battery operation.

A further problem which has been considered to be present for conversion anodes is a marked (dis-)charge voltage hysteresis. This is addressed by the sea urchin structures. The nature of the carbon nanotube network resulting from the sea-urchin structures is that each active core is essentially a node of the network. This limits the proportion of active material that may become inaccessible to electrons or lithium-ions during battery operation.

With respect to the elevated operational potentials of many conversion materials being considered also to limit the achievable energy density, this problem is considered to be addressed by the composition of the core particles. Furthermore, high voltage cathodes are now available.

It is considered that the Al—Fe—O alloy enables higher rates (high current density charge/discharge) and life (cycle number) than pure iron oxide based electrodes. This is at present thought to be due to a stabilising effect of Al.

The nature of the carbon nanotube network resulting from the sea-urchin structures, each active core being essentially a node of the network, ensures good electrode electrical conductivity, which contributes to good battery performances at high current rates.

Similarly, the nature of the carbon nanotube network resulting from the sea-urchin structures, each active core being essentially a node of the network, ensures good electrode thermal conductivity, which contributes to enhanced battery thermal management and ultimately battery safety

The layer of material according to the sixth aspect may be capable of self support. For example, the layer of material may have a tensile strength, measured on the layer without the presence of a supporting substrate, of at least 1 MPa.

In the method according to the seventh aspect, the precursor particles are preferably subjected to combustion heat treatment in a furnace set to a temperature of not more than 500° C. More preferably, the precursor particles are subjected to combustion heat treatment in a furnace set to a temperature of not more than 400° C., not more than 300° C. or not more than 250° C.

Preferably, the precursor particles are supported together in the furnace on a combustion heat treatment solid substrate. In some embodiments, the solid substrate may move, e.g. rotate. Consequently, the particles may flow to some extent. However, the precursor particles at this stage of the process are not free-floating.

Similarly, preferably the core particles are supported together during carbon nanotube growth on a carbon nanotube growth solid substrate. In some embodiments, the solid substrate may move, e.g. rotate. Consequently, the core particles may flow to some extent. However, the core particles at this stage of the process are not free-floating.

The core particles contain one or more voids, generated during drying or during combustion of the combustible component. There may be provided networks of nanopores/nanochannels of diameter about 1 nm extending throughout the particle. Additionally or alternatively there may be hollow/multishell particles with thickness of about 10-100 nm for each shell, the remainder of the particle being hollow.

The combustible component may be a carbon-based material, soluble in the solution. For example, the combustible component is a carbohydrate material, such as sucrose or maltodextrin.

Further optional features of the invention are set out below.

The indication “Fe-Al-Li-O” is intended to indicate a composition which includes Fe, Al, O and optionally Li. The presence of other elements is not necessarily excluded. However, in some preferred embodiments, the indication “Fe-Al-Li-O” may designate a composition which consists of Fe, Al, O and optionally Li, and optionally up to 10 wt % of further components, including incidental impurities.

### BRIEF DESCRIPTION OF THE DRAWINGS

Embodiments of the invention will now be described by way of example with reference to the accompanying drawings in which:

FIG. 1D shows a schematic illustration of the experimental setup for CNTSU synthesis and characterization and SEM images of (FIG. 1A) salt nanoparticles collected downstream of the silica gel drier, (FIG. 1B) bimetallic nanoparticles collected downstream of furnace 1, (FIG. 1C) CNTSUs collected downstream of furnace 2.

FIGS. 2A, 2B and 2C show the schematic experimental setup for (FIG. 2A) particle mobility size distribution measurement, (FIG. 2B) particle mass measurement for a fixed particle mobility, (FIG. 2C) thermophoretic particle collection for further CNT growth or ex-situ characterisation.

FIGS. 3A-3F show XRD characterisation of cores collected downstream of furnace 2. (FIG. 3A) Raw data and peak locations, (FIG. 3B) peak 1, (FIG. 3C) peak 2, (FIG. 3D) peak 3, (FIG. 3E) peak 4. Raw data is shown as the thinnest line, calculated data is shown in the medium thick line, background data in the thickest line. Vertical lines correspond to peak position and relative intensity for magnetite (short dash line), our sample (medium dash line), and hercynite (long dash line). dₛ refers to the crystallites Scherrer size and x_{H} refers to the proportion of hercynite in the solid solution according to Veggard's rule.

FIGS. 4A-4C show the results of XPS characterisation of cores collected downstream of furnace 2. Short Ar⁺ etching prior to measurement, shifted with reference to C2s. (FIG. 4A) Fe2p region, (FIG. 4B) Al2p region, (FIG. 4C) O1s region. Raw data is shown in the top line in each graph and all other peaks and background were fitted according to the method described in the text.

FIGS. 5A-5K show various SEM images as follows:

FIG. 5A: 200 nm diameter cores CNTSUs collected downstream of second furnace 114 with acetylene flowrate C₂H₂=5 sccm and furnace temperature T₂=750° C.,

FIG. 5B: C₂H₂=5 sccm, T₂=800° C.,

FIG. 5C: C₂H₂=5 sccm, T₂=1000° C.,

FIG. 5D: C₂H₂=50 sccm, T₂=750° C.,

FIG. 5E; C₂H₂=50 sccm, T₂=800° C.,

FIG. 5F: C₂H₂=50 sccm, T₂=1000° C.,

FIG. 5G: C₂H₂=30 sccm, T₂=800° C. (nominal conditions).

FIG. 5H: SEM image of an individual substrate-grown CNTSU,

FIG. 5I: cores thermophoretically deposited onto a silicon wafer downstream of first furnace 110,

FIG. 5J: the same wafer as in FIG. 5I after CNT growth for 20 minutes in a CVD furnace, and

FIG. 5K: CNTSUs synthesised in the gas phase thermophoretically deposited onto a silicon wafer downstream of second furnace 114 with the same collection time as (FIG. 5I).

FIG. 6A shows SMPS size distribution of cores downstream of second furnace 114 without acetylene and CNTSUs.

FIG. 6B shows mass-mobility equivalent diameter relationships for cores downstream of second furnace 114 without acetylene and CNTSUs measured using a CPMA.

FIG. 7 shows an SEM image of an individual CNTSU.

FIG. 8 shows an SEM image of an individual core particle, without CNTs.

FIG. 9 shows an SEM image of an individual CNTSU on which EDX characterization was carried out.

FIGS. 10a-10d show TEM images of the interface between CNTs and cores for CNTSU structures.

FIG. 11 shows an SEM image of a CNTSU film.

FIG. 12 shows an SEM image of a battery electrode that was prepared with CNTSUs, PVDF, and NMP on a copper current collector

FIG. 13 shows TGA data for the CNTSUs.

FIG. 14 shows a schematic cross sectional view of a lithium ion battery according to an embodiment of the invention.

FIG. 15 shows a schematic view of the cores and carbon nanotubes of CNTSUs.

FIG. 16A shows a schematic view of an individual nanostructure and FIG. 16B shows an SEM image of such a nanostructure.

FIG. 16C shows a schematic view of a nanostructured film formed from an assembly of nanostructures and FIG. 16D shows an SEM image of such a nanostructured film.

FIG. 17 shows galvanostatic charge-discharge profiles of (FeₓAl₁₋ₓ O_{y})-MWCNT electrodes at 50 mA/g.

FIG. 18 shows galvanostatic cycling of (FeₓAl₁₋ₓ O_{y})-MWCNT electrodes.

FIG. 20 shows galvanostatic charge-discharge profiles of a full cell: (FeₓAl₁₋ₓ O)-MWCNT/LNCO (lithium nickel cobalt oxide).

FIG. 21 shows galvanostatic charge-discharge profiles for electrodes formed from core particles of FeₓAl₁₋ₓ O_{y} physically mixed with MWCNTs.

FIG. 22 is an example of a web-type diagram to compare two batteries (A and B) over a number of performance metrics.

FIG. 23 qualitatively compares an embodiment of the present invention with a conventional graphite-based lithium ion battery and with a typical nanostructured silicon-based lithium ion battery over a number of performance metrics.

FIGS. 24a-24e show, for the sample reported in FIG. 3:

FIG. 24a: SEM image of the sample

FIGS. 24b-24d: EDX elemental maps for O, Fe and Al, respectively

FIG. 24e: EDX spectrum.

FIG. 25 illustrates a suitable lab-scale process for manufacturing an anode according to a preferred embodiment of the invention.

FIG. 26 illustrates a further process for manufacturing CNTSUs.

FIG. 27 shows a schematic illustration of the anchoring of a CNT to a core particle via an integral protrusion of the core particle extending into the CNT. Only one CNT is illustrated, but it will be understood that a typical CNTSU has many CNTs anchored to the core particle.

FIG. 28 shows an SEM image of spray-dried, un-combusted particles (after stage 1) formed using a modified process.

FIG. 29 shows an SEM image of combusted particles (after stage 2) formed of Fe—Al—O based on the un-combusted particles of FIG. 28.

FIGS. 30 and 31 show SEM images at different magnifications of CNTSUs (after stage 3) formed using the particles of FIG. 29.

FIG. 32 shows the results of galvanostatic cycling, for a half cell configuration, for the CNTSUs of FIG. 29.

FIG. 33 shows the results of cyclic voltammetry, for a half cell configuration, for the CNTSUs of FIG. 29.

FIG. 34 shows the TGA results for the CNTSUs. The thick line shows the fraction of initial weight (left axis). The thin line shows relative weight variation rate (right axis [%/C]).

FIG. 35 shows the results of galvanostatic cycling, for a half cell configuration using CNTSUs formed with different Fe/Al ratio, different O content and different CNT content (8 wt %).

FIGS. 36 and 37 show SEM images of sea-urchins with ZnFe₂O₄ cores.

FIG. 38 shows the results of galvanostatic cycling, for a half cell configuration using the CNTSUs with ZnFe₂O₄ cores.

FIG. 39 shows the results of cyclic voltammetry, for a half cell configuration using the CNTSUs with ZnFe₂O₄ cores.

FIGS. 40, 41 and 42 show SEM images of sea-urchins with NCA cores.

### DETAILED DESCRIPTION OF THE PREFERRED EMBODIMENTS, AND FURTHER OPTIONAL FEATURES OF THE INVENTION

As explained above, it is preferred to consider battery technologies in the light of how well they perform on a number of metrics, the combination of which will ultimately give one technology a competitive advantage for one specific application. Examples are given in Table 1, which is taken from Glaize & Genies (2013).

TABLE 1
Example of storage requirements for given applications

| Application | Important design metrics |
|---|---|
| Boat engine starter batteries | Cost, W/kg, Wh/kg |
| Handling machinery, wheelchairs, | Cost, Wh/kg |
| electric bicycles, etc. | |
| Traction batteries for electric | Wh/kg, Wh/L, W/kg, cyclability, |
| vehicles: cars (hybrids, PHEVs | little or no maintenance |
| and EVs), scooters, golf buggies, | |
| go carts | |
| Storage for autonomous energy | Wh/kg, cyclability with no |
| systems (solar, wind, | maintenance |
| telecommunications, pleasure | |
| boating) | |
| Storage for grid-connected energy | Cost |
| systems | |
| Mobile devices, wireless tools, | W/kg, Wh/kg, Wh/L, cyclability |
| vacuum cleaners, memory | with no maintenance |
| preservation | |
| Aeronautics and space (autonomous | Wh/kg, cyclability with no |
| onboard grid) | maintenance |

Some terminology relating to battery technology is now explained, in order better to understand the context of comparing the performance of different batteries. This is again taken primarily from Glaize & Genies (2013).

Energy Density

The total energy stored in a battery is the product of its capacity by its voltage. It is expressed in kilo watt hours (kWh). The capacity, expressed in ampere-hour Ah (same dimension as coulomb C) is the amount of charge that the battery can store in the active material in the form of lithium ions. The voltage, expressed in volts (V), refers to the electrical potential difference between the anode and the cathode. It is the driving force that enables the lithium ions to shuttle from one electrode to the other.

A distinction must be made between the total stored energy and the deliverable energy, which is the quantity that matters for the consumer. There are inevitable losses in the battery system (poor conductivity of the active material that is not entirely accessible electrically, etc.), and in practice some restrictions must be enforced on the levels of lithiation/delithiation that the active materials/electrolyte can sustain without degrading irreversibly. In other words the depth of charge and discharge should be actively limited. The deliverable energy density depends on the operating current, the allowed depth of discharge, the temperature, and the target cycle life of the battery. Although by definition the total energy of the battery does not depend on the battery operating conditions, the deliverable energy does. This is the reason why the energy density of a battery should be stated given a precisely defined operating conditions context. However, this is often not the case for figures found on the existing battery manufacturers' website or in the media, making general one-to one comparison of batteries rather difficult.

This concept of deliverable energy, as opposed to total energy, transfers to the notions of capacity and voltage. Theoretical capacity and open circuit voltage are different to nominal capacity and useful voltage. Nominal capacity and useful voltage are linked to a specific context, and their product gives the deliverable energy in this context. For example, the theoretical capacity of silicon is 10 times higher than that of graphite (the commercial standard for anode active material), and this is the figure often quoted out of context, but this is meaningless as only a fraction of that capacity can be used in practice, silicon being extremely prone to degradation at high currents or prolonged battery operation. Transition metal oxides, upon which the present technology is based, have a lower theoretical capacity (only 3 to 4 times that of graphite), but a much larger fraction of that capacity can be used in practical operations as this material is more robust, leading to levels of nominal capacity that can be greater or lower than silicon depending on the operating conditions, and therefore the end application. Likewise the open circuit voltage depends solely on the electrochemistry of the anode and cathode active materials, but the useful voltage is smaller and depends on the engineering constraints dictated by the battery operating conditions.

Additionally, some applications have requirements in terms of gravimetric energy density, expressed in kWh/kg, whereas others have requirements in terms of volumetric energy density, expressed in kWh/L, depending on whether weight or volume of the battery is the most important parameter to optimise for a given application. Here battery energy is normalised by the weight or the volume of the battery, respectively. This depends primarily on the properties of the active materials, but also on the overall battery design.

Power Density

As shown above, the charge and discharge currents are key operating parameters defining the deliverable energy stored in the battery. This can also be understood in terms of power density. Power is expressed in kW and power density is expressed in kW/kg, or kW/L. It can be understood as the maximum achievable power (e.g. that achieved in starter batteries for a short duration), or the maximum acceptable power over a given duration, that is actively limited for reasons of heat generation or active material degradation for instance. It is the product of the battery voltage by the charge or discharge current. Properties of the battery active material dictate an upper electrical current that can be extracted from the battery, either because of concerns about the cycle life of the battery, or because the current is physically limited by the amount of lithium ions that can be extracted from the active material in a given time (diffusion-limited operation for instance). To further complicate the matter, in the case of a battery the voltage is inversely proportional to the current being drawn, with a proportionality factor that depends on the composition of the active material (its electrical conductivity in particular).

Linked to the notion of power density is the notion of acceptance current. This is the maximum current that can be used to recharge the battery, and is therefore related to the battery charging time. As above it is limited either by the kinetics of the electrochemical reactions in the active material, or by safety/cycle life considerations.

Battery Lifetime

Cyclability is the ability of the battery to maintain nominal or dose to nominal performances in terms of energy and power density over a large number of charge-discharge cycles for given operating conditions. Over cycles the battery energy density and power density degrade—this phenomenon is called aging—eventually leading to battery failure. This is routinely experienced by smartphone users keeping the same phone for more than a few months. It is an important requirement in the automotive industry as the battery accounts for a significant portion of the total cost of vehicles, and must withstand daily charge and discharge for years. It is beyond the scope of this document to discuss the mechanisms of aging, but suffice it to say that it is dependent on the chemistry of the electrode active materials and on the operating conditions. Higher currents, higher operating temperatures, and deeper charges/discharges lead to accelerated aging. In terms of materials chemistry, the main drawback of silicon is its very poor cyclability.

Other metrics such as faradaic efficiency, shelf life, self-discharge may be of importance for some applications but are usually not the most constraining factors for battery lifetime. These concepts will be understood by the skilled person, with reference for example to Glaize, C., & Genies, S. (2013).

Safety

The weak point preventing the widespread introduction of Li-ion batteries to high-energy onboard or stationary applications is its lack of tolerance to abusive operation such as over-charging or high temperatures. Thermal runaway is the catastrophic failure of the battery whereby self-sustained temperature rises in the system lead to electrolyte evaporation that causes risks of hazardous gas leakages, combustion, or explosion.

Susceptibility to thermal runaway depends on the operating conditions, the inherent electrochemistry of the active materials (their propensity to generate temperature rises), and the overall battery design (the capability of the battery to safely dissipate any excessive heat being generated).

Versatility

Versatility can be understood in a number of ways. In some contexts this refers to the capability to operate the battery in high temperature environments, which is typically a requirement for cars, due to the concerns over energy density, power density, cyclability, and safety losses associated with high temperatures. In other context this refers to the capability of the battery to operate in low temperature environments. This is a requirement for cars that operate in a cold climate, and for aeronautics and space applications. It is a problem as the kinetics of lithium ion electrochemical reactions are slowed down by low temperatures leading to dramatic decreases in performances unless special measures are taken.

Versatility can refer to additional mechanical capabilities of the battery, such as being transparent, being folded, flexed, weaved, stretched, rolled, cut open, etc. These are typical requirements for the next generation of consumer electronics wearables. Again, versatility depends on the operating conditions requirements, the overall battery design, and the choice of active materials for the electrodes.

Cost and Sustainability

A distinction should be made between the cost of the entire battery, the cost of one cell, and the cost of the active material itself. A detailed description of typical battery manufacturing processes is out of the scope of this disclosure. However, in a typical battery manufacturing process active materials are generally supplied to the battery assembly line as a powder that is roll-coated onto current collectors. This powder can be synthesised in house on a separate manufacturing line, or most often bought from an external supplier. Ideally, active materials must be synthesised from available, affordable compounds, and the process itself should not be costly.

Glaize & Genies, 2013 estimate the purchasing cost of Li-ion batteries in 2013 to lay between €400/kWh and €2000/kWh. As will be understood, battery prices change quickly with evolving technology and improvements in manufacturing efficiency. However, note that the price per kilowatt-hour is only one metric, which does not take into account the other parameters mentioned above. Excluding processing, the cost of battery-grade graphite delivering a capacity of 325 mAh/g can be estimated to be $2.2/kg in 2013, that is about 0.07$/Ah. Accounting for the other components of the electrode and the processing cost, the total anode cost is about 0.13$/Ah in 2013. Anode material cost accounts for about 50% of the anode cost, but that is only about 8% of the total battery cost. For this reason, there is room for significantly more expensive anode materials, especially if they enable higher specific capacities (mAh/g) as this translates to longer electric vehicle range.

How can we Compare Batteries?

From the explanation above it is clear that one figure only, such as the energy density, or even the price per kilowatt-hour, cannot be used to compare the relative merits of different batteries.

An alternative approach is to use web-type diagrams such as the one shown in FIG. 22. If only the energy density figure was given, one would conclude that battery A is better than battery B. The web diagram tells a more complete story, and it may be that for a given application—say electric vehicles—battery B is actually more suitable than battery A.

However this methodology is not necessarily perfect. As explained above the different metrics are all interdependent. For instance an energy density figures makes sense only if the required power density/discharge current and cyclability performances are specified. For this reason the only rigorous way to compare batteries is to fully specify the operating conditions for which the comparison is being made. This is what the US Advanced Battery Consortium (USABC) recommends (see http://www.uscar.org/guest/article_view.php?articles_id=85 accessed 21 Sep. 2016). An example of their benchmark for electrical vehicles is given in table 2. Comparisons are then only valid for a given context, which is chosen as being best representative of the requirement for a specific application. Every major electric vehicle research project funded by the US government uses this as a benchmark.

TABLE 2
USABC Goals for Advanced Batteries
for EVs - CY 2020 Commercialization

| End of Life | | | |
|---|---|---|---|
| Characteristics at 30° C. | Units | System Level | Cell Level |
| Peak Discharge Power | W/L | 1000 | 1500 |
| Density, 30 s Pulse | | | |
| Peak Specific Discharge | W/kg | 470 | 700 |
| Power, 30 s Pulse | | | |
| Peak Specific Regen | W/kg | 200 | 300 |
| Power, 10 s Pulse | | | |
| Useable Energy Density | Wh/L | 500 | 750 |
| @ C/3 Discharge Rate | | | |
| Useable Specific Energy | Wh/kg | 235 | 350 |
| @ C/3 Discharge Rate | | | |
| Useable Energy @ C/3 | kWh | 45 | N/A |
| Discharge Rate | | | |
| Calendar Life | Years | 15 | 15 |
| DST Cycle Life | Cycles | 1000 | 1000 |
| Selling Price @ 100K units | $/kWh | 125 | 100 |
| Operating Environment | ° C. | −30 to +52 | −30 to +52 |
| Normal Recharge Time | Hours | <7 Hours, | <7 Hours, |
| | | J1772 | J1772 |
| High Rate Charge | Minutes | 80% ΔSOC in | 80% ΔSOC in |
| | | 15 min | 15 min |
| Maximum Operating | V | 420 | N/A |
| Voltage | | | |
| Minimum Operating | V | 220 | N/A |
| Voltage | | | |
| Peak Current, 30 s | A | 400 | 400 |
| Unassisted Operating at | % | >70% Useable | >70% Useable |
| Low Temperature | | Energy @ C/3 | Energy @ C/3 |
| | | Discharge rate | Discharge rate |
| | | at −20° C. | at −20° C. |
| Survival Temperature | ° C. | −40 to +66 | −40 to +66 |
| Range, 24 Hr | | | |
| Maximum Self-discharge | %/month | <1 | <1 |

The goals listed in Table 2 are far out of reach for commercially available batteries at the time of writing.

Next we disclose processes for the manufacture of suitable anode materials and details of the characterization of such materials.

Processes for the Manufacture of Materials According to Embodiments of the Invention, and the Characterization of Such Materials

### INTRODUCTION

In the present disclosure, we focus on a continuous gas-phase carbon nanotube (CNT) production process that relies on a three-dimensional organisation of CNTs around a central particle in a structure named Carbon Nanotube Sea Urchin (CNTSU).

Here CNTSUs are broadly defined as microscale structures whereby CNTs are grown radially from a central nano or micro particle, which is usually referred to as the core of the sea urchin. Early accounts of such architecture include magnetic hollow nickel microspheres covered with oriented CNTs [Han et al (2006)], boron nitride/CNT composite particles synthesised using a spray-pyrolisis route [Nandiyanto et al (2009)], CNT forests grown on spherical alumina microparticles via a CVD method [He et al (2010 and 2011)], or boundary layer CVD synthesis of radial filled CNT structures [Boi et al (2013)].

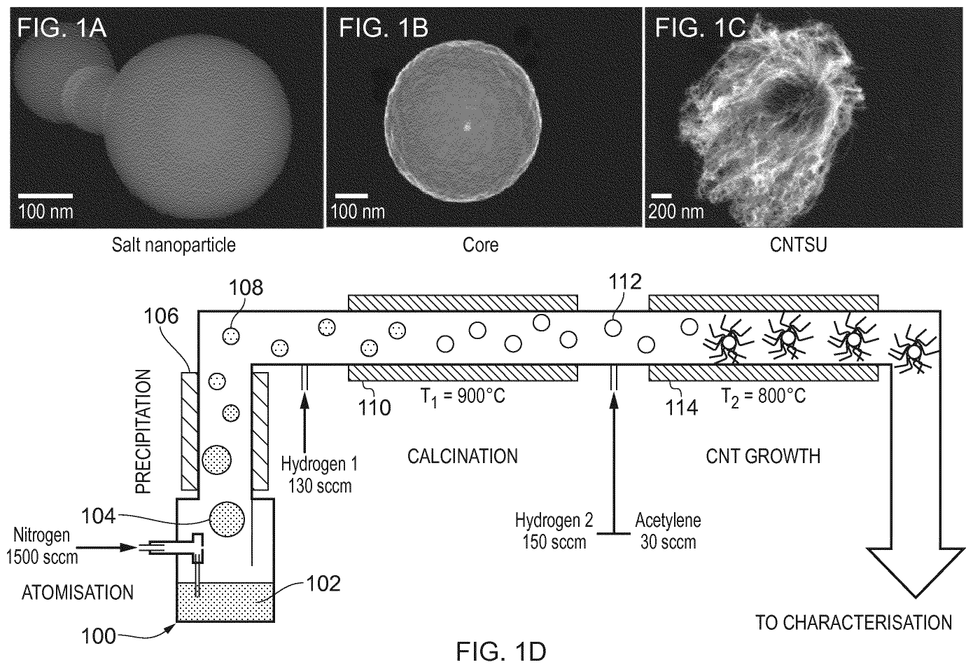

This disclosure focuses on the most studied process to date, which was first reported in Kim et al (2011) whereby an aerosol of CNTSUs with bimetallic nanoscale cores is continuously synthesised in the gas-phase. As shown in FIG. 1D, an aqueous solution of aluminium nitrate Al(NO₃)₃ and iron nitrate Fe(NO₃)₃ is atomised in a stream of nitrogen carrier gas, creating a polydisperse microdroplets aerosol. As water evaporates from the droplets, solute concentration increases, eventually leading to precipitation of the metal nitrate salts, thus forming bimetallic salt nanoparticles (FIG. 1A) suspended in the gas-phase. These nanoparticles then undergo calcination in a high temperature reducing environment, typically a tube furnace with a small addition of hydrogen to the carrier gas, enabling the formation of bimetallic nanoparticles that will act as CNTSU cores (FIG. 1B). Upon addition of acetylene (C₂H₂) and a new addition of hydrogen, CNTs grow radially from the surface of the cores in a second CVD tube furnace, leading to CNTSUs as shown in FIG. 1C. As with most aerosol-based nanomaterial processes, this synthesis route is continuous and solvent-free. It relies on cheap precursors and combines two widely used methods—spray pyrolysis and CVD—that are used to manufacture most of the world's industrial production of nanomaterials such as carbon black, TiO₂ and other metal oxide nanopowders, or bulk CNT powder. Regarding the fundamental phenomena at play during synthesis, the mechanism leading to catalytic site formation at the surface of the cores is key to the understanding and optimisation of the process. Kim, Wang et al (2011) briefly investigates the composition of cores collected downstream of the calcination furnace via X-ray diffraction (XRD), leaving an open question as to whether the surface of the cores is composed of nanometer-size catalytically-active crystallites of iron oxide embedded in an inert matrix of aluminium oxide, or whether iron and aluminium oxides form a single amorphous phase of AlₓFe_{y}O_{z}. However the former hypothesis seems to be favoured in the rest of that paper, where it is postulated that this hypothetic segregated structure could originate from the difference in solubilities of aluminium nitrate and iron nitrate. As aluminium nitrate solubility in water is lower than that of iron nitrate, it may be that upon droplet drying, aluminium nitrate preferentially precipitates at the droplet solidification front, so that the surface of cores is aluminium-enriched relative to iron, with small patches of iron nitrate isolated by a matrix of aluminium nitrate. Following that reasoning, this structure would be retained during calcination and CNT growth to form pure iron metal catalytic sites in a matrix of aluminium metal or aluminium oxide. Additionally, Kim, Wang et al (2011) shows that the coverage density of CNTs can be tailored by tuning the Al:Fe ratio in the precursor solution. In Kim, Ahn et al (2011), where iron nitrate is replaced with nickel nitrate, the same hypothesis is accepted on the mechanism of catalytic site formation and shows that variation of core size and process temperatures enable tuning of the resulting particle morphology, from straight and coiled individual CNTs to CNTSUs. Both of these papers base the explanation of their findings on the assumption that iron and aluminium segregate in two separate phases within the cores, starting from the precipitation stage to the CNT growth stage. Owing to their enhanced heat transfer properties, with all CNTs being interlinked via a central thermally conductive core, thus enabling control of CNT-CNT junctions and facilitating dispersion in other media, these CNTSUs have found applications as diverse as nanofluid coolant additives [Han et al (2007), additive to bulk heterojunction polymer-fullerene solar cells as an exciton dissociation medium, or as an optical igniter in the explosion of nanoenergetic thermite materials [Kim et al (2014)]. However, none of these applications take advantage of the fact that CNTSUs are true hybrid materials, where the core could add functionality to the material independently of its role as an inert thermally conductive architecture element. This may be attributed to the lack of material characterisation of the core, including its exact chemical composition and crystallographic structure.

This disclosure provides new characterisation data showing that contrary to what was assumed so far in the literature, cores are composed of an amorphous AlₓFe_{y}O_{z} alloy which composition is quantified. This leads to the proposition of a new mechanism for catalytic site formation, whereby catalytic sites nucleate at the surface of the cores upon cooling in the downstream temperature gradient of the calcination furnace, effectively decoupling catalytic site formation and CNT growth from the initial metal nitrate precipitation stage. Building on that finding, which indicates that the process is more versatile than what was originally thought as it does not rely on the initial structure created upon droplet precipitation, we show that CNTSU morphology can be tuned independently of core size and composition by changing the operating parameters of the CVD growth furnace, and that CNT length, density, and quality can be increased to unprecedented levels with a novel hybrid aerosol-substrate CVD growth process that results in the formation of CNTSU carpets.

Experimental Methods

CNTSU Synthesis

The apparatus for CNTSU synthesis is illustrated in FIG. 1D. A one-jet collision nebulizer 100 is used to atomize an aqueous solution 102 (100 mL) of 2 w. % aluminium nitrate and 2 w. % iron nitrate (Sigma-Aldrich ACS reagent grade and type II deionized water) in a 1500 sccm flow of nitrogen carrier gas. The resulting aerosol (geometric mean diameter of about 1 μm as measured with a PALAS Welas digital 1000H optical aerosol spectrometer) is then passed through a custom-made silica gel drier 106 where close to 100% of the stream moisture content is removed. The resulting dry metal nitrate salts nanoparticles 108 then enter a calcination furnace 110, furnace 1, operated at T₁=900° C. together with an additional flow of hydrogen at a flowrate of 130 sccm. Downstream of the first furnace 110, the bimetallic nanoparticles aerosol 112 is further mixed with a 150 sccm flow of hydrogen and a 30 sccm flow of acetylene before entering the CVD growth furnace 114, furnace 2, operated at a temperature T₂=800° C. Total process time is about 10 s. These operating conditions (flowrates and temperatures) are referred to as the nominal conditions in what follows. Both furnaces 110, 114 are electrical tube furnaces with about 50 cm heated lengths, equipped with 1 m long, 19 mm inner diameter alumina worktubes. All gases are BOC 99.998% purity compressed gases, HEPA filtered and controlled using Alicat MC series mass flow controllers.

X-Ray Diffraction. X-Ray Photoemission Spectroscopy, and Scanning Electron Microscopy

For the purpose of X-ray diffraction (XRD) studies, about 50 mg of core particles were collected downstream of furnace 2 with the system operated at nominal conditions except that no acetylene was introduced in furnace 2. Particles were filtered using a PTFE membrane filter (1.2 μm pore size, Cole Parmer). The powder was loaded on a 10 mm diameter sample holder and analysed using a Bruker D8 theta/theta diffractometer operated with a Cu Kα radiation source with 2θ=10-80° at a scan rate of 0.3°/min (2θ) and a step size of 0.019° (2θ). Diffraction data was interpreted using the PANalytical X'Pert HighScore software operating with standard background and peak fitting techniques.

X-ray photoemission spectroscopy (XPS) was performed on particles collected at various locations in the system listed in Table 3, on a silicon wafer using the thermophoretic precipitator described below. Collection time was about 1 h, enough time to coat the wafer with a layer of particles of thickness >10 μm as confirmed by scanning electron microscopy (SEM). Samples were analysed using a Thermo Scientific Escalab 250Xi UPS/XPS photoelectronic spectrometer. Scans were recorded with a monochromatic Al Kα anode X-ray source with a power of 210 W, 650 μm spot size and the adventitious carbon Is peak at 284.8 eV as a reference marker to detect sample charging, which was neutralised with an electron flood gun. An Ar+ ion gun was used for sample cleaning and depth profiling at an ionization energy of 1000 eV with a beam current of 2.5 μA for 0, 60, or 920 s prior to measurement. The etch rate was estimated to be about 0.2 nm s⁻¹. XPS spectra were collected from an area of 300 μm² on the substrate, with an interaction depth estimated to be about 10 nm. XPS data was interpreted using the Thermo Scientific Avantage software. For each sample a survey scan was first carried out, followed by high resolution scans on the spectral regions of interest. Fe2p multiplet peaks were fitted using a Shirley background substraction and 75% Gaussian 25% Lorentzian line shapes, as recommended in Lin et al (1997).

TABLE 3
List of sample collection locations
and etching time for XPS experiments.

| Sample | Collection | Etching time [s] |
|---|---|---|
| 1 | Downstream of drier | 60 |
| 2 | Downstream of furnace 1 | 60 |
| 3a | Downstream of furnace 2, no C₂H₂ | 60 |
| 3b | Downstream of furnace 2, no C₂H₂ | 920 |
| 4 | Downstream of furnace 2 | 0 |

All Scanning Electron Microscope (SEM) images were obtained by collecting particles, either cores or CNTSUs, on silicon wafers using the thermophoretic precipitator described below, and imaging them using a LEO Gemini 1530VP SEM.

Energy Dispersive X-Ray Spectroscopy was performed by collecting core particles on silicon wafers using the thermophoretic precipitator described below, and imaging them using a LEO Gemini 1530VP SEM equipped with an Oxford Instrument EDS detector.

Scanning Mobility Particle Sizer and Centrifugal Particle Mass Analyser

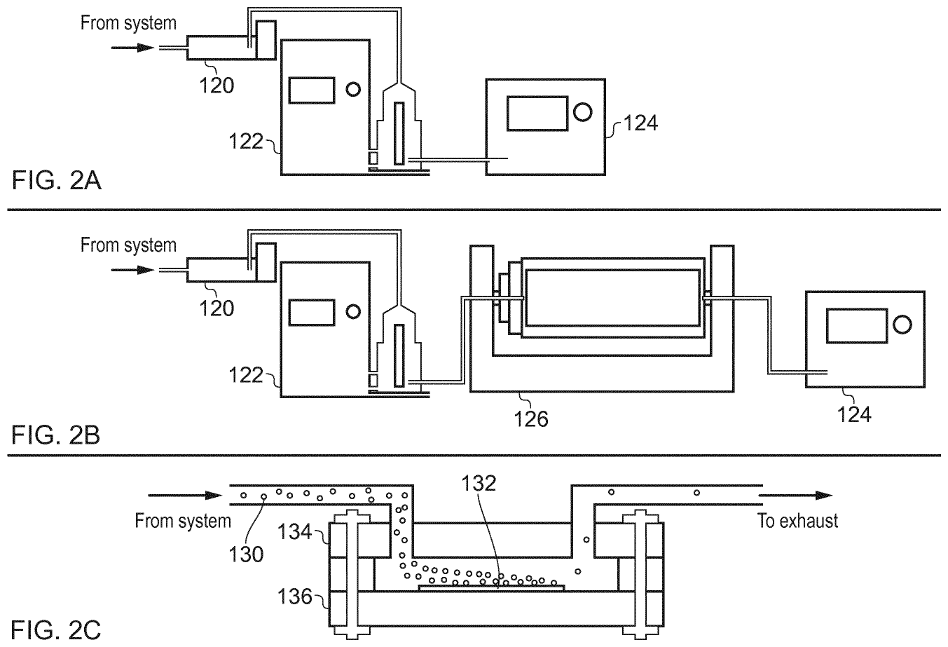

The Scanning Mobility Particle Sizer (SMPS) is a common in-line aerosol characterization tool used to measure particle size distribution based on their mobility equivalent diameter. As shown in FIG. 2A, the aerosol to be characterized, either cores or CNTSUs in our case, is first given a known bipolar charge distribution by means of collisions with gaseous ions in a device called a neutraliser (TSI 3087 soft X-ray neutraliser). The aerosol then enters a Differential Mobility Analyser 122 (TSI 3080 DMA operated in closed loop with a sheath flowrate of 10 L min⁻¹) where it is classified according to its mobility equivalent diameter as a result of the balance between electrical and drag forces acting on particle trajectories within the device. Concentration of classified particles is then measured with an optical particle counter 124 (TSI 3076 Condensation Particle Counter operated in high flow mode). As the DMA 122 voltage is scanned from low values where small particles are classified to high values where large particles are classified, it is possible to construct the particle size distribution of the aerosol initially entering the SMPS [Flagan (2008)]. Mobility equivalent diameter is defined as the diameter of a perfectly spherical particle bearing one positive elemental charge that would have the same electrical mobility (that is the same ratio of drag to electrical forces in the DMA) as the particle being measured. Particle size distributions were measured using this apparatus downstream of the second furnace 114, both at nominal conditions to characterise CNTSUs and at nominal conditions but no acetylene to characterise cores.

The Centrifugal Particle Mass Analyser (CPMA) 126 shown in FIG. 2B in contrast to FIG. 2A is an in-line aerosol classifier that classifies particles according to their mass-to-charge ratio. Particles are injected in between two concentric cylinders rotating at different speeds, while a potential difference is applied between both cylinders. Particle trajectories result from the balance between electrical and centrifugal forces acting onto them, which ultimately depends on their mass to charge ratio. Particles making it through the CPMA 126 are counted by a CPC 124. Assuming particle charge is known, by scanning the rotation speed of the cylinders it is possible to construct the aerosol particle mass distribution [Olfert and Collings (2005)]. The CPMA (Cambustion Ltd.) was operated downstream of a DMA as shown on FIG. 2B, in a setup similar to that of Graves et al (2015). A polydisperse aerosol, either cores or CNTSUs, enters the neutraliser 120 (TSI 3087) and is classified in the DMA 122 (TSI 3080) operated in closed loop with a sheath flowrate of 10 L min⁻¹ and a fixed voltage. A monodisperse aerosol of known mobility bearing 1 positive elemental charge per particle therefore exits the DMA to enter the CPMA where mass distribution of the aerosol is measured with the help of TSI 3076 CPC operated in high flow mode. In a procedure similar to that of Graves et al (2015), a lognormal distribution curve is fitted to each mass distribution in order to extract a representative particle mass for a given mobility. This method was used downstream of the second furnace 114, both at nominal conditions to characterise CNTSUs and at nominal conditions but no acetylene to characterise cores in order to establish mass-mobility relationships.

Thermophoretic Precipitator

A thermophoretic precipitator, as shown in FIG. 2C, was built to collect particles 130 from the gas-phase onto a silicon wafer 132. The motivation to build this device was to be able to deposit a large area (about 5 cm²) uniform film of cores with controlled thickness onto any substrate (not necessarily a filter) in order to enable the substrate-based CNTSU CVD growth experiment described below. This technique has advantages compared to the alternative technique of filtering the aerosol with a PTFE membrane followed by contacting a silicon wafer onto the filter to transfer the collected nanoparticles with the help of capillary forces from a drying solvent. These include lower contamination levels, more uniform and thickness-controlled film deposition, and, in the case of CNTSUs, no modification or densification of the CNT structures under the action of capillary forces. The thermophoretic precipitator consists of two aluminium plates 134, 136 separated by a thin (about 1 mm) air gap created by a thermally insulating gasket as shown in FIG. 2C. One plate (hot plate 134) is heated to about 300° C. with a flat pad ceramic heater, while the other (cold plate 136) is water cooled to about 10° C. The aerosol entering the gap in-between the two plates is subjected to a force from the hot side to the cold side arising from the temperature gradient. For spherical particles with uniform temperature one can define a thermophoretic velocity

$${v}_{th} \approx - 0.54 v \frac{∇ T}{T}$$

where ν is the gas kinematic viscosity and T [K] the absolute temperature of the gas, that curves particle trajectories towards the cold plate 136 where they are collected on a substrate (typically a silicon wafer 132). This design was inspired by Gonzalez et al (2005). The coated silicon wafer can then be taken to a CVD furnace for CNT growth, or for ex-situ characterisation.

Substrate-Based CNTSU CVD Growth

Cores were collected downstream of first furnace 110 with the system operated at nominal conditions onto a silicon wafer of area about 1×1 cm using the thermophoretic precipitator described above. Collection time was about 60 min to ensure full coverage of the wafer and >10 μm coating thickness as confirmed by SEM. The wafer was then transferred to a horizontal tube furnace where it underwent thermal CVD at atmospheric pressure, with flows of 100/400/100 sccm C₂H₄/H₂/He, at 800° C. with a 20 min growth time. The resulting CNTSUs were rapidly cooled in the growth atmosphere before purging the CVD chamber with helium. This approach is described in Ahmad et al (2016).

Modified Process for Manufacture of CNTSUs

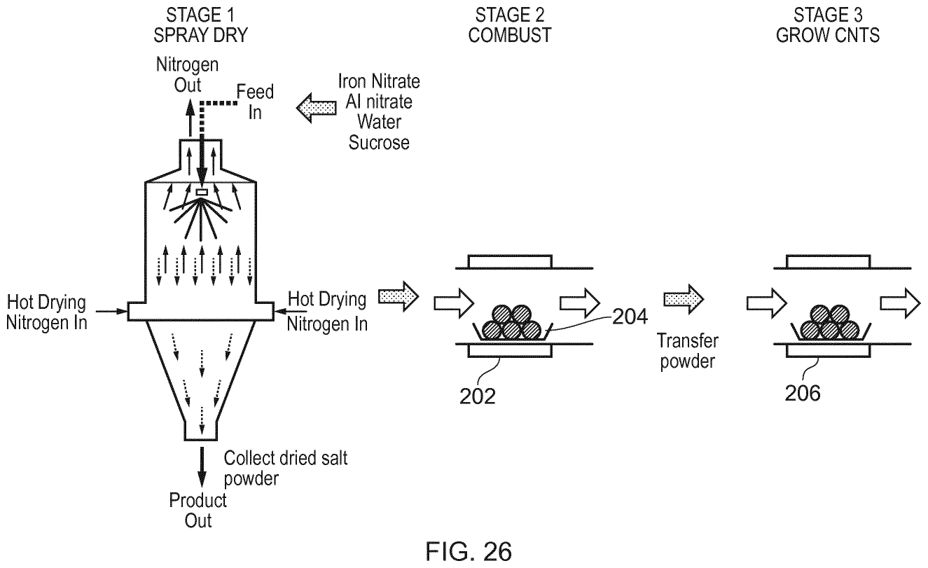

FIG. 26 shows a schematic illustration of a modified process for manufacturing CNTSUs. The process has three stages, identified as stage 1 (spray dry), stage 2 (combust) and stage 3 (grow CNTs). These stages are discussed in more detail next.

In stage 1, an aqueous solution of aluminium nitrate, iron nitrate, and sucrose is spray-dried using a commercially available spray-drier 200 to form a dry precursor powder of aluminium nitrate+ iron nitrate+sucrose microparticles.

Suitable iron and aluminium nitrate concentrations are typically about 40 wt. %, although the concentrations can be from 1 wt. % up to the solubility limit for the salts used in the relevant solvent at the temperature range of interest. Note that other solvents can be used, such as ethanol or acetone, provided that the precursors are soluble. Note also that other iron and aluminium salts can be used. The present inventors have confirmed for example that citrates, tartrate, sulfates can be used. Furthermore, the carbon source is not necessarily sucrose. In fact, in one preferred embodiment, sucrose is not used and maltodextrin is used instead. Any suitable soluble carbon source can be used, such as glucose. The sucrose (in this example) is dissolved/solvated. Where maltodextrin is used, a typical concentration is 8 wt. %. However, other embodiments may use concentrations in the range 2-30 wt. %.

For stage 2, the precursor powder collected from stage 1 is then taken out of the collection chamber and into a calcination reactor (furnace 202). Here, it is not free floating. Instead, it is held in a container such as a ceramic crucible 204, or on a substrate such as a ceramic substrate, or on a silicon wafer or metal strip. The atmosphere in the calcination reactor is an inert atmosphere (e.g. nitrogen or helium). It is possible to use an oxidising atmosphere, such as air. In stage 2, the precursor powder is heated gently to start a combustion reaction between the nitrates and the sucrose, which results in forming mixed metal oxides particles (i.e. the core particles). The temperature in the calcination reactor is set to about 200° C., for example. A suitable range for the temperature in the calcination reactor is 100-1000° C. In an alternative embodiment, the precursor powder may be held on a wall of the furnace 202, such as on the inner surface of the tube insert into the furnace 202. This tube may be rotated around its principal axis.

In stage 3, the core particles are then transferred to another furnace 206 for growing CNTs. In the CNT growth furnace, the core particles are once again not free floating but are held in a container such as a ceramic crucible, or on a substrate such as a ceramic substrate, or on a silicon wafer or metal strip. Carbon nanotubes are then grown in accordance with the carbon nanotube growth conditions described above. Alternative carbon nanotube growth conditions can be used, as will be understood by the skilled person, such as replacing acetylene by ethylene, and/or with different flowrates and relative concentrations. In a similar manner as for stage 2, in an alternative embodiment, the core particles may be held on a wall of the furnace 206, such as on the inner surface of the tube insert into the furnace 206. This tube may be rotated around its principal axis.

Results and Discussion

Chemical Composition of Cores

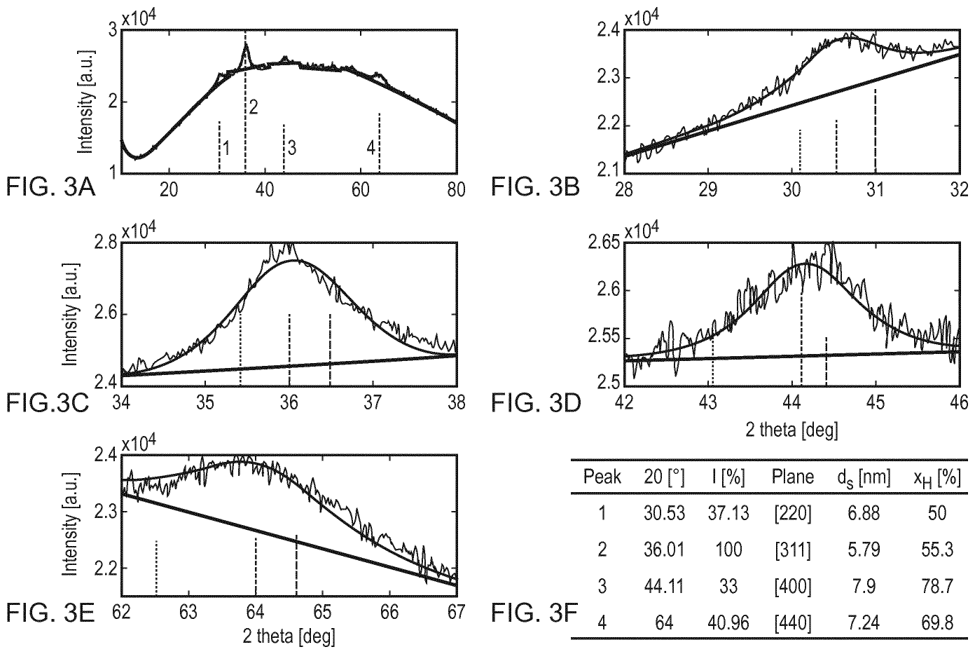

XRD results are shown in FIGS. 3A-3F. The pronounced hump in the raw data presented in FIG. 3A indicates that the sample is amorphous to a large extent, although artefacts such as over-illumination, air scattering, or iron fluorescence may contribute marginally to this large background noise. Quantitative determination of the proportion of amorphous to crystalline material is possible in theory but unpractical with this set of data. Peaks are relatively broad (about 1°) while the instrument broadening is <0.1°, which indicates that the crystallites dispersed in the sample are small. Four peaks, identified in FIG. 3A, were deemed to be well defined enough to enable further interpretation of the spectrum. These are shown on FIGS. 3B to 3F, together with the fitted peaks and background.

Quantification of crystallite size dₛ via the Scherrer equation is shown in Table 4, which corresponds to FIG. 3F, shown with FIGS. 3A-3E for convenience. Results are relatively consistent across peaks, with Scherrer sizes ranging from dₛ=5.8 nm to dₛ=7.9 nm. Regarding crystal domain composition, the location and relative intensities of these peaks are compatible with a solid solution of hercynite Al₂FeO₄ (CAS 00-034-0192) into magnetite Fe₃O₄(CAS 00-019-0629). Corresponding peak locations and relative intensities are shown by vertical lines in FIGS. 3B to 3E. It can be seen that peak location for our sample falls in-between peak locations for hercynite and magnetite in all cases. Magnetite and hercynite both crystallise in a cubic system with the normal spinel structure. Each peak is attributed to a given plane reflection in Table 4. Tumock and Eugster (1962) has shown that lattice parameter of magnetite-hercynite solid solution varies continuously with the degree of substitution. Using Veggard's rule it is theoretically possible to determine the proportion x_{H} of hercynite in the solid solution, as shown in Table 4 (see Tumock and Eugster (1962)). Unfortunately results are not consistent across peaks, from x_{H}=50% to x_{H}=80%, which could be explained by the difficulty to accurately fit such broad peaks, possible stacking faults that are common in this Fe-Al-O system [Tumock and Eugster (1962)] (especially with regards to peak 3), or inherent limitations to Veggard's rule. Although the chemical composition of the amorphous and crystalline parts of the sample are usually assumed to be the same in that kind of situation, XRD does not give any direct information on the amorphous part of the sample, which accounts for the majority of the material, it is therefore necessary to use another characterisation method, EDX, to fully determine the chemical composition of the cores.

TABLE 4
XRD characterization of peaks indicated in FIG. 3.a (quantification
of crystallite size d_{S}via the Scherrer equation)

| Peak | 2θ [°] | I [%] | Plane | d_{S} [nm] | x_{H} [%] |
|---|---|---|---|---|---|
| 1 | 30.53 | 37.13 | [220] | 6.88 | 50 |
| 2 | 36.01 | 100 | [311] | 5.79 | 55.3 |
| 3 | 44.11 | 33 | [400] | 7.9 | 78.7 |
| 4 | 64 | 40.96 | [440] | 7.24 | 69.8 |

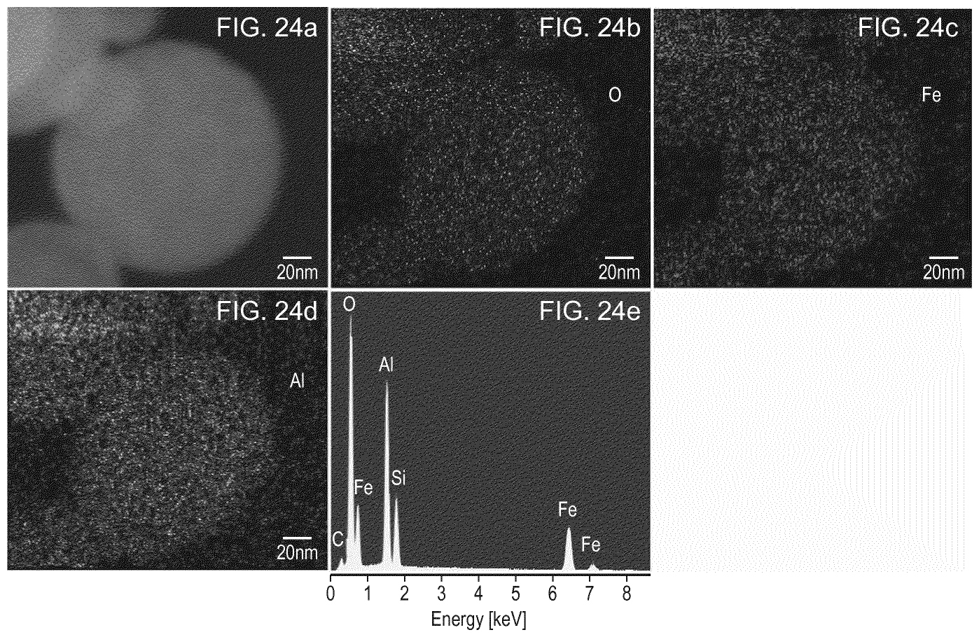

A scanning electron microscope image, elemental maps and an EDX spectrum, are reported in FIGS. 24a-24e respectively for the sample previously studied in FIGS. 3A-3F. As expected the sample is mostly composed of Al, Fe, and O as C and Si can be attributed to contamination and wafer background respectively. Elemental maps show that the cores are composed of an alloy of Al/Fe/O in the atomic proportions of 1.4/1/4.1 (see Table 5a for quantitative composition analysis). The atomic composition ratio of Al to Fe is 1.4, which is close to the 1.14 ratio that can be expected considering that Al(NO₃)₃ and Fe(NO₃)₃ are present in equal weight proportions in the atomiser precursor solution.

TABLE 5a
EDX characterization of sample of FIG. 24a

| Element | W. % | At. % |
|---|---|---|
| Al | 19.16 | 16.51 |
| Fe | 31.12 | 12.95 |
| O | 36.90 | 53.63 |
| C | 5.67 | 10.98 |
| Si | 7.18 | 5.94 |

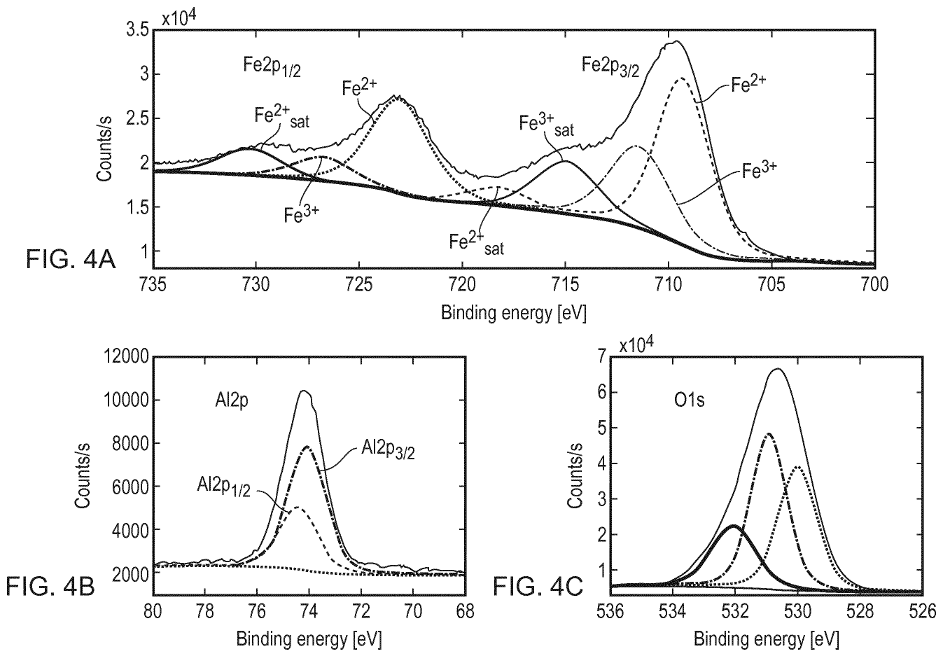

XPS spectra of the sample reported in FIGS. 3A-3F are shown in FIGS. 4A-4C. As expected, initial sample surveys revealed the presence of iron (FIG. 4A), aluminium (FIG. 4B), oxygen (FIG. 4C), and contributions of carbon and silicon (not shown) that can be attributed to contamination (from the atmosphere and from the walls of furnace 2) and wafer background respectively. The Fe2p spectrum shown on FIG. 4A is complex, but presents similarities with typical spectra recorded for magnetite thin films as in Lin et al (1997), which facilitated peak attribution to given chemical states of the element, as labelled on FIG. 4A. Interestingly no Fe(0) can be detected in the sample, as it would have produced a characteristic peak centred around lower binding energies (about 706 eV). Both Fe(II) and Fe(III) are present in significant proportions, as seen in the Fe2p_{3/2} and Fe2p_{1/2} regions, where both primary and shake-up satellite peaks were recorded. As previously reported in the littérature [Lin et al (1997)] no satellite peak was detected for Fe(III) in the Fe2p₂ region. Although the peak fitting procedure is robust enough to qualitatively state that both Fe(II) and Fe(III) are present, it was decided not to attempt a quantitative determination of the Fe²⁺ to Fe³⁺ ratio, as this would require specialist procedures as described in [Lin et al (1997)], that are out of the scope of this work. This difficulty arises because of the complex nature of Fe2p spectra, featuring spin-orbit splitting, multiple oxidation states and satellite structures [Lin et al (1997)]. Overall, Fe2p spectra are compatible with the hypothesis of a solid solution of hercynite into magnetite for crystaline domains, these small domains being dispersed in an amorphous matrix of the same chemical composition. In the magnetite spinel structure Fe²⁺ occupy octahedral sites while Fe³⁺ occupy tetrahedral sites. In the hercynite spinel structure Fe²⁺ occupy octahedral sites while Al³⁺ occupy octahedral sites, but this compound is known to present a large degree of cation exchange between octahedral and tetrahedral sites, giving a significant portion of Fe³⁺ and Al²⁺[Harrison (1998)]. The Al2p spectrum shown on FIG. 4B is in accordance with the results obtained for pure hercynite in Alan et al (2015) and Velon et al (2001), with two closely spaced spin-orbit components characteristic of aluminium oxides at 74.08 eV and 74.42 eV. No Al(0) was detected. The O1s spectrum shown on FIG. 4C was fitted with three peaks at 530.03 eV, 530.96 eV, and 532.1 eV which are likely to result from the mixed contributions of the O²⁻ oxygen in the oxides and oxygen from hydroxides, water and carbonaceous species. Using standard quantification techniques, including built-in relative structure factor from the Thermo Scientific Avantage software, sample stoichiometry was quantified for samples 1 to 4. A summary of the results is available in Table 5b. For sample 3a, which was discussed above, it appeared that the significant levels of carbon contamination made quantification of the oxygen content delicate. It was therefore decided to perform a prolonged etching (about 180 nm) to remove impurities from the sample surface. Taking sample 3b as a reference, neglecting oxygen contribution from carbon contamination and silicon wafer background, it appears that the relative proportions of Al/Fe/O are 2.6/1/4.2 for the surface of the cores at this point in the system. XPS only gives access to the first approximately 10 nm of the sample surface. A side-effect of the deep etching performed on sample 3b is that a depth profiling is effectively carried out. Sample 3a corresponds to the approximately 10 nm closest to the core surface exclusively, whereas sample 3b gives access to a greater portion of the interior of the cores from a statistical point of view. This may explain the about 20% difference in Al/Fe ratio between both samples, that should not have been affected by impurity removal; it may be that at this point in the system cores are slightly Fe enriched at their surface. In theory the Al/Fe atomic ratio should be about 1.14 as Al(NO₃)₃ and Fe(NO₃)₃ are present in equal weight proportions in the atomiser precursor solution. It is interesting to track the evolution of this Al/Fe ratio at different point in the system, as shown in Table 5b. Downstream of the drier (sample 1) Al/Fe=2.9. Downstream of furnace 1 (sample 2), Al/Fe=3.6, which may indicate that cores at this location in the system have an aluminium-enriched surface, contrary to what was found for cores downstream of furnace 2 as discussed above. Assuming the concentration gradient resulting from the precipitation of the metal nitrate salts is preserved during calcination, this would be in agreement with the proposition of Kim, Wang et al (2011) that aluminium nitrate precipitates first upon droplet drying. This concentration gradient would then be inverted in the second furnace. Finally XPS of grown CNTSUs (sample 4) do not reveal any nitrogen doping or oxidation of the CNTs.

TABLE 5b
Summary of quantification results for XPS experiments, relative atomic
composition in %.

| Sample | Al | Fe | O | C | Si | N | Al/Fe |
|---|---|---|---|---|---|---|---|
| 1 | 27.4 | 9.5 | 49.5 | 4.9 | 5.1 | 4.4 | 2.9 |
| 2 | 40.8 | 11.4 | 40.5 | 3.7 | 2.9 | 0 | 3.6 |
| 3a | 22.7 | 10.9 | 43.4 | 15.3 | 8.3 | 0 | 2.1 |
| 3b | 28.8 | 11.2 | 47.0 | 3.1 | 9.0 | 0.7 | 2.6 |
| 4 | 0.78 | 0 | 2.0 | 97.1 | 0.2 | 0 | N/A |

To conclude on the question of core composition downstream of the second furnace 114, it can be said firstly that cores are composed of small (<10 nm) crystalites of a solid solution of hercynite into magnetite with a proportion of hercynite comprised between 50% and 80%, dispersed in an amorphous matrix that represents the majority of the sample. Secondly, neither XRD nor XPS suggest that Al and Fe are segregated into distinct phases. If that were the case it is likely that Fe20₃ would be the main Fe phase, which is not coherent with the significant proportion of Fe(II) identified via XPS. Moreover no Al₂O₃ phase could be detected via XRD. This is not surprising as Tumock and Eugster (1962) has shown that hercynite and magnetite form full solid solutions above 850° C. (see also Golla-Schindler (2005)). Thirdly, overall atomic ratio of Al/Fe/O was estimated to be 1.4/1/4.1. Fourthly, there are indications that core composition is not uniform along core radius and that this composition evolves in the second furnace 114.

Investigation of CNT Growth

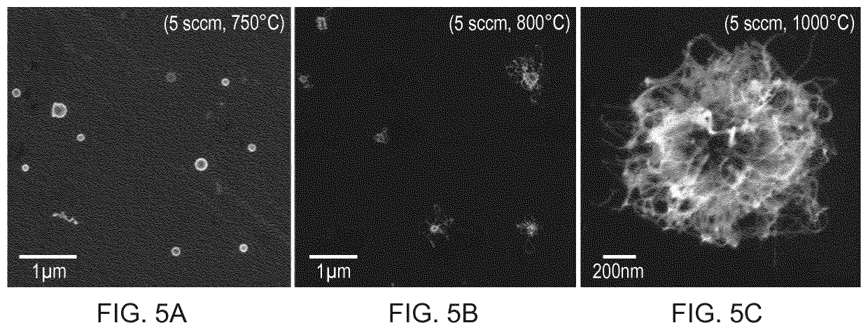

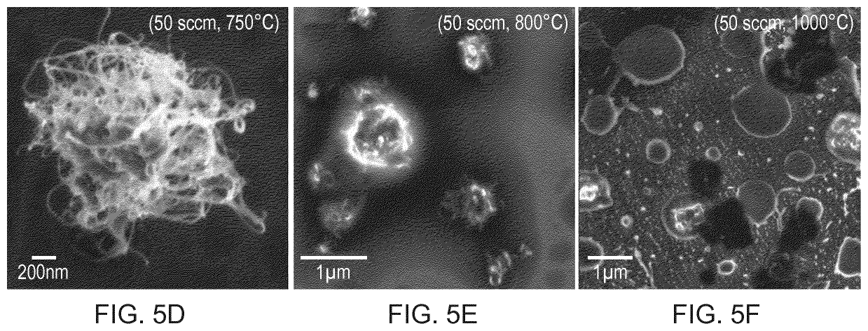

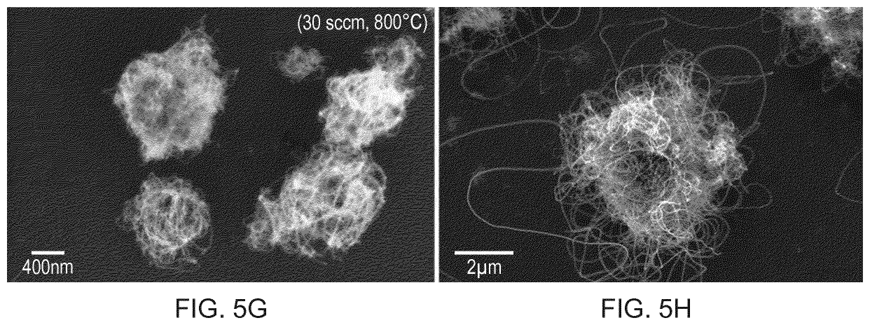

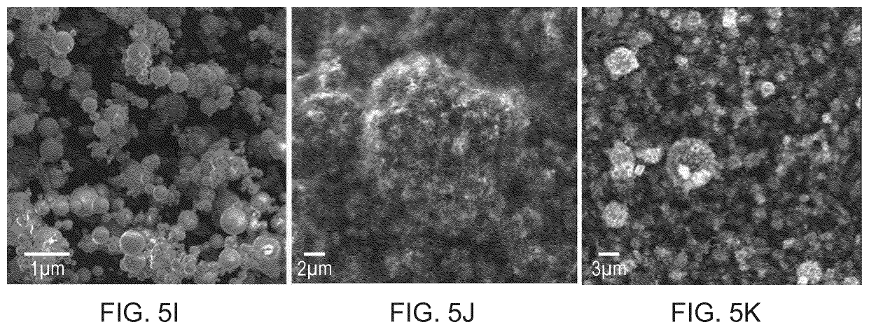

In the light of this new information on core composition, a new hypothesis on the mechanism of catalytic site formation and CNT growth can be formulated. We propose that small crystalline domains that nucleate in the downstream temperature gradient of the first furnace 110 and are separated from each other by an amorphous matrix act as catalytic sites for the growth of CNTs in the second furnace 114. The crystalline domains in questions would be those identified in the XRD study reported above. Their size (<10 nm) is compatible with their role as catalytic sites for CNT growth and with the diameter of resulting CNTs (see FIG. 1C for instance) given the epitaxial nature of CNT growth. Nanocrystals with similar size and composition have been shown to be efficient catalysts for the growths of CNTs by CVD. Lee et al shows that CNT carpets can be grown from aluminium ferrite nanocrystals and aluminium iron oxide nanocrystals deposited onto alumina coated silicon wafers. These crystals were synthesised by colloidal methods and it is shown that the quality of CNTs grown from these crystals is better that that of CNTs grown from comparable pure iron oxide materials. The authors speculate that the presence of aluminium in the catalyst slows down the decomposition of acetylene at the catalyst surface, leading to less amorphous carbon production. Moreover Morales et al (2013) demonstrates the synthesis of a CNT-hercynite composite by CVD from a FeOₓ—AlOOH xerogel as catalyst. The authors show that CNTs grow from 10 to 50 nm diameter hercynite nanoparticles. In a following part of this disclosure we explore the implications of this new catalytic site formation mechanism on the synthesis of CNTSUs from a process development point of view. This mechanism suggests that the process is more versatile than what was originally thought, as it does not rely on the ability of the initial structure created upon droplet precipitation to survive the harsh conditions experienced in furnaces 110 and 114. This allows for more freedom with the operating parameters (flowrates and temperatures), which are varied in FIGS. 5A-5G to influence the length, coverage density, and quality of CNTs being grown on the surface of cores.

FIGS. 5A, 5B, 5C, 5D, 5E, 5F, 5G are SEM images of particles collected downstream of second furnace 114 with (acetylene flowrate Q_{C}_{₂}_{H}_{₂}, second furnace temperature T₂) parameters equal to respectively (Q_{C}_{₂}_{H}_{₂}=5 sccm, T₂=750° C.), (Q_{C}_{₂}_{H}_{₂}=5 sccm, T₂=800° C.), (Q_{C}_{₂}_{H}_{₂}=5 sccm, T₂=1000° C.), (Q_{C}_{₂}_{H}_{₂}=50 sccm, T₂=750° C.), (Q_{C}_{₂}_{H}_{₂}=50 sccm, T₂=800° C.), (Q_{C}_{₂}_{H}_{₂}=50 sccm, T₂=1000° C.), and nominal conditions (Q_{C}_{₂}_{H}_{₂}=30 sccm, T₂=800° C.), with all other system parameters nominal. A DMA was inserted between the first and second furnaces so that only Dₚ=200 nm cores make it to the growth furnace 114, so that core size does not influence CNT growth as suggested by Kim, Ahn et al (2011). Visual examination of these SEM pictures shows that FIG. 5G (nominal conditions) is a local optimum in terms of CNT quality and amount of CNT grown per core. As could be anticipated, lower acetylene flowrate with lower (FIG. 5A) or equal (FIG. 5B) growth temperatures lead to little or no CNT growth. Higher growth temperature with higher (FIG. 5F) or equal (FIG. 5E) acetylene flowrate lead to highly defective CNT growth/amorphous carbon coating of the sample. Finally, lower acetylene flowrate and higher growth temperature (FIG. 5C) or higher acetylene flowrate and lower growth temperature (FIG. 5D) lead to the growth of CNTs with poor quality. However carefully optimised the nominal conditions shown in FIG. 5G were, CNT loading per particle and CNT quality are fundamentally limited by the time available for CNT growth, which is linked to the residence time in second furnace 114. One could increase heated length or tube diameter to increase growth time, but there are practical limits to this approach, including the fact that larger diameter worktubes lead to higher inhomogeneities in the produced particles as particles which trajectory is close to the tube wall have a different temperature and precursor partial pressure history than those who follow the centre line of the tube. This issue also arises when production scale up is needed, which is of particular interest to industrial applications of this process: one suitable way to increase throughput is to use multiple jets atomisers operating with higher flowrates, leading to smaller residence time in second furnace 114 unless tube diameter is increased. To overcome this problem, the substrate-based CNTSu growth approach described above was developed, allowing for a growth time of 20 min or more vs. about 5 seconds in the gas-phase process. An individual CNTSU grown according to this technique is shown on FIG. 5H, to be compared with the best results from the gas-phase technique shown on FIG. 5G. CNTs are longer (CNTSU diameter about 8 μm vs. 1.5 μm) with a higher coverage density of the cores and improved quality (thinner, straighter CNTs overall). FIG. 5I shows cores that were thermophoretically deposited onto a silicon wafer downstream of first furnace 110 at nominal conditions, and were subsequently inserted in the substrate-based growth CVD furnace for 20 minutes, resulting in the CNT carpet shown on FIG. 5J. This carpet is to be compared with the CNTSU film shown in FIG. 5K that was obtained by collecting gas-phase produced CNTSUs for the same time as cores were collected for FIGS. 5I and 5J. Interestingly, substrate-grown CNTSUs seem to entangle to create a thick (about 100 μm thick) dense carpet, potentially enhancing CNTSU-CNTSU interfacing in terms of electrical and thermal conductivity.

In-Line Monitoring of CNT Growth

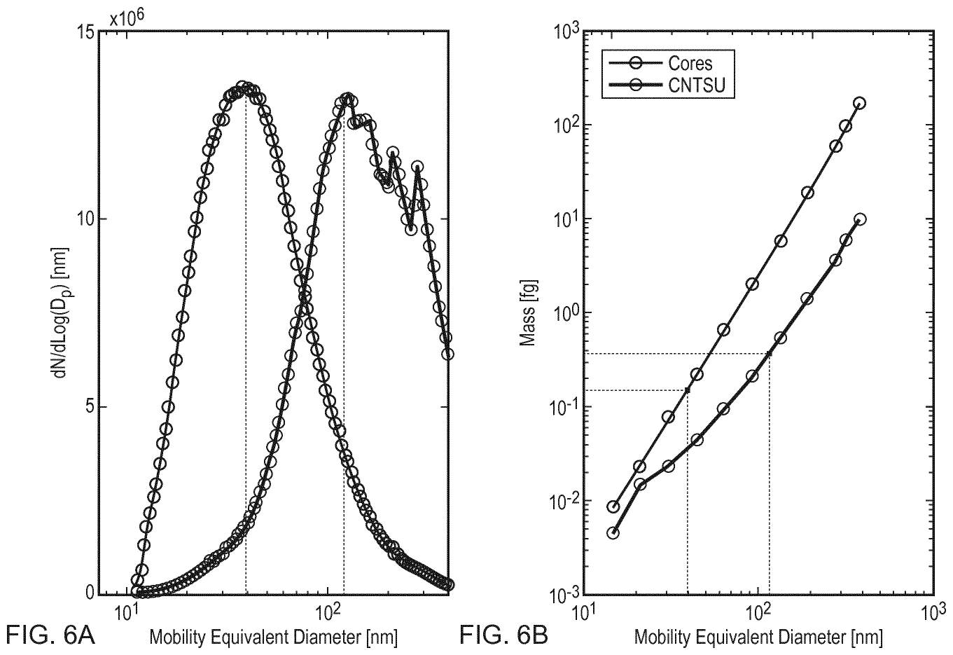

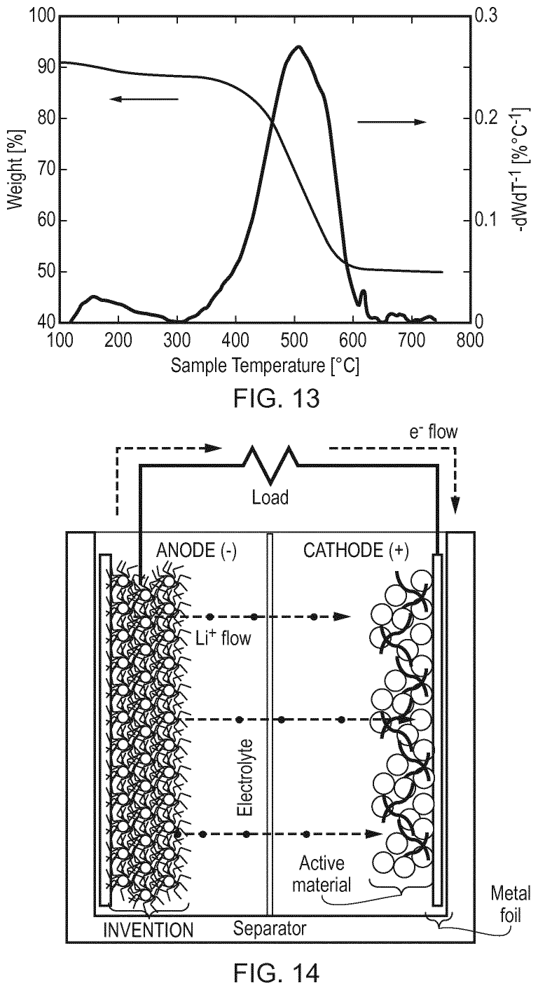

Optimisation of nominal conditions as shown on FIGS. 5A-5K is a slow process, involving running the system with a set of operating conditions, collecting a sample, analysing it with an SEM, and then selecting another set of operating parameters for iteration. This is greatly improved with an in-line monitoring technique allowing for direct and quantitative estimation of mass and quality of grown CNTs. In an industrial setup such an optimisation process can be automated. Hence it is of interest to develop the inline-monitoring technique relying on aerosol differential mobility analysis and centrifugal mass classification described above. FIG. 6A shows particle mobility equivalent diameter distributions measured downstream of second furnace 114 for cores and CNTSUs with the system run at nominal conditions. The addition of carbon to the second furnace and the resulting growth of CNTSUs is witnessed by the shift of the mode of the distribution towards larger diameters (about 40 nm vs. about 120 nm). Total particle concentration is the same for both conditions (about 10⁷/cm³). However this information on the shift in mode is not sufficient to assess CNTSU growth. Coating of cores by large amounts of amorphous carbon such as in FIG. 5F could produce the same result. This is why additional information on the mass of individual particles measured using the CPMA is needed. As shown in FIG. 6B, one can establish mass-mobility equivalent diameter relationships for both cores and sea urchins. The slope of these curves is proportional to the effective density of the particles. As expected cores have effective density about 6 times higher than fully grown CNTSUs. Any sub-optimal CNTSU growth, be it shorter CNT growth or amorphous carbon coating of the cores is expected to lead to intermediate effective densities, which can be quickly quantified with this in-line technique. Another interesting piece of information from FIG. 6B is the higher effective density of CNTSUs for small diameters (dₚ<30 nm) compared to larger diameters. This indicates that CNT growth is not as effective in the case of these small cores. This phenomenon has been highlighted by Kim, Ahn et al (2011) where it was shown that small cores lead to particle morphologies that differ from regular CNTSUs. Finally, FIGS. 6A and 6B can be used to estimate the mass of CNTs grown per core. Assuming that all cores in the mode of the core distribution shown in FIG. 6A result in CNTSUs whose diameter is the mode of the CNTSU distribution after growth, and substracting the corresponding CNTSU and core masses for these diameters as shown in FIG. 6B, the mass of CNTs per particle for the mode of the distribution is about 0.2 fg/CNTSU, that is about 50% of total CNTSU mass. This is confirmed by independent thermogravimetric analysis (TGA) experiments as shown in FIG. 13.

Discussion of Results for Modified CNTSU Manufacturing Process

Following the manufacturing process set out in FIG. 26 provides certain practical advantages. For example, it is found that the combustion reaction used in the process of FIG. 26 is energy efficient, in that cores can be formed at the low temperature of 200° C. This compares with temperatures of 900° C. or higher in U.S. Pat. No. 8,628,747.

Furthermore, in U.S. Pat. No. 8,628,747, it is necessary to use hydrogen in the furnace for the formation of the core particles. Hydrogen is expensive and is typically the most important operational cost in such processes. Not using hydrogen also makes the process safer and easier to implement industrially.

In the spray dryer, the present inventors have found that it is possible to recycle the carrier gas (e.g. hot nitrogen) used in the spray-drier. This improves efficiency. It is notable that it is would be very difficult to recycle the spray dryer carrier gas in U.S. Pat. No. 8,628,747.

It is found that the combination of spray drying and combustion enables the creation of voids within the core particles, in the form of porosity and/or hollow structures within the core particles. This is considered to be advantageous from the point of view of applying the material in a battery. Methods for producing hollow structures in this manner are disclosed in WO2014183169, although not in the context of CNTSUs.

The present inventors have found that they are able to increase their throughput by about 1000 times (from 100 mg/day to 100 g/day) compared with the throughput possible based on U.S. Pat. No. 8,628,747, but still at the laboratory scale, using apparatus of similar cost.

Conclusion

XRD, EDX, and XPS characterisation showed that cores of CNTSUs produced using the floating substrate process with equal concentrations of aluminium nitrate and iron nitrate precursors by weight are mostly composed of an amorphous alloy of Al/Fe/O in the molar proportions 1.4/1/4.1 downstream of the CNT growth furnace following exposition to the atmosphere. Small crystalline domains (Scherrer size <8 nm) composed of a solid solution of hercynite into magnetite are embedded into this amorphous matrix. Our insight, based on existing literature, is that these crystallites act as catalytic sites for the growth of CNTs from the surface of the cores in the second furnace. We further hypothesise that these crystal nucleate in the calcination furnace downstream temperature gradient, effectively decoupling catalytic site formation and CNT growth from the initial structure created upon droplet precipitation. Demonstration that CNT growth can be controlled independently of core composition by tuning system operating parameters is in accordance with this assumption. Inherent limitation to CNT length and quality resulting from the limited residence time for CNT growth in the gas-phase process are overcome with the demonstration of a new substrate-based CVD growth of CNTSUs enabling unprecedented CNT length, quality and density coverage of CNTSUs. We report the formation of CNTSU carpets resulting from this process. Finally we propose a novel in-line characterisation technique combining differential mobility analysis and centrifugal mass classification to continuously monitor the growth of CNTs in the gas-phase process.

Further Details and Discussion of Preferred Embodiments of the Invention

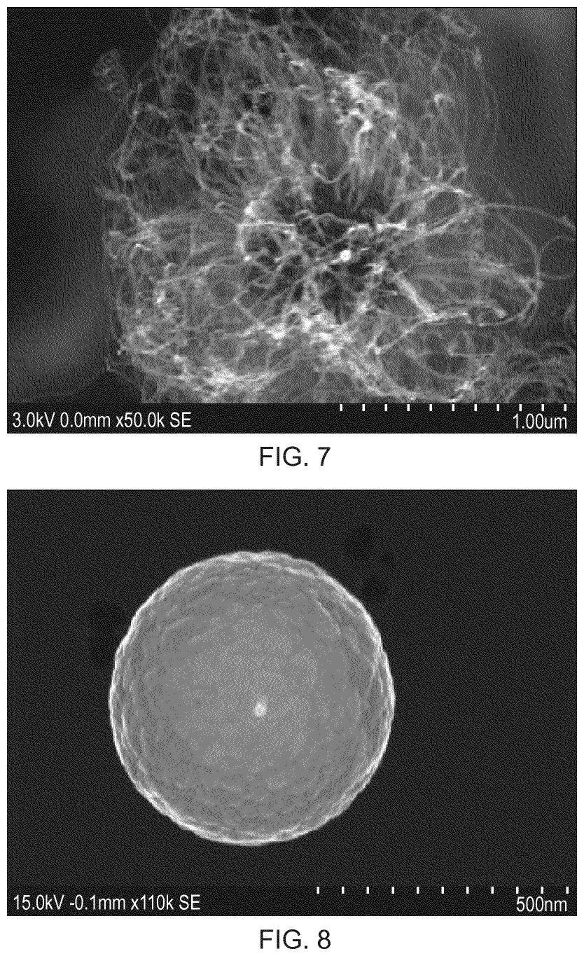

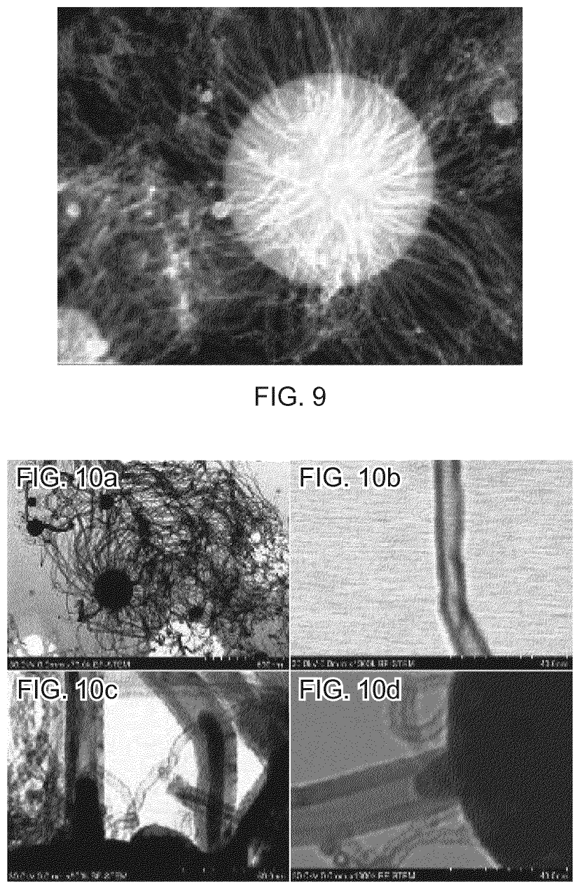

FIG. 7 shows an SEM image of an individual CNTSU. In contrast, FIG. 8 shows an SEM image of an individual core particle, without CNTs.

FIGS. 10a-d show TEM images of the interface between CNTs and cores for CNTSU structures. These show that CNTS are covalently/well/epitaxially bonded to the cores, with significant filling of CNTS by the catalyst particle. These images also show a typical CNT diameter of about 10 nm.

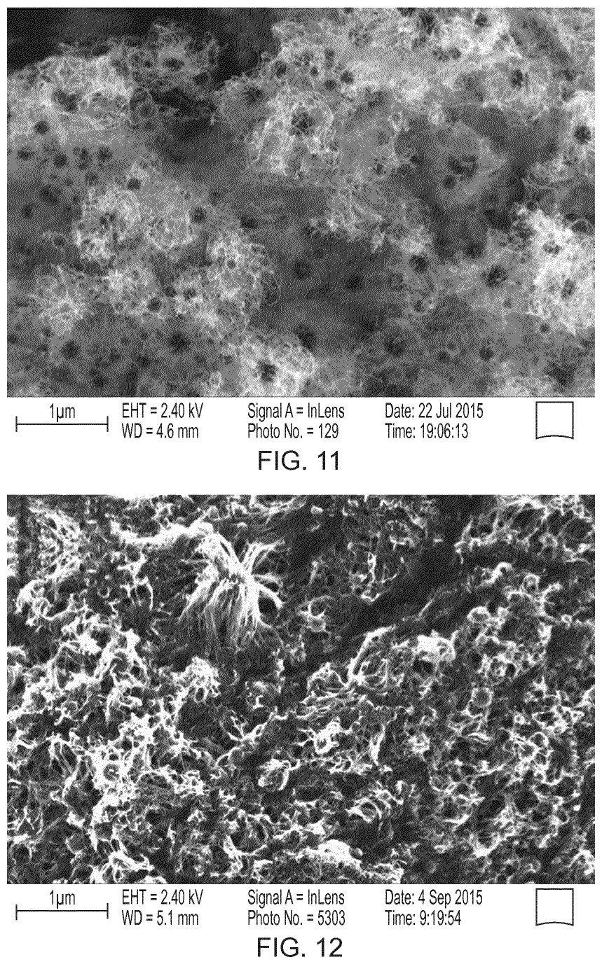

FIG. 11 shows an SEM image of a CNTSU film.

FIG. 12 shows an SEM image of a battery electrode that was prepared with CNTSUs, PVDF, and NMP on a copper current collector

FIG. 13 shows TGA data for the CNTSUs. The data indicates that the quality of the CNTs is rather variable and that there is a range of different CNTs. The TGA data allows a determination of the mass of CNTs relative to the mass cores in a typical CNTSU sample. In this case it is about 40 wt %. Note that the invention is not necessarily limited to this proportion. It is possible to operate in a wide range of proportions, from 0% up to 100% or more (e.g. 200%).

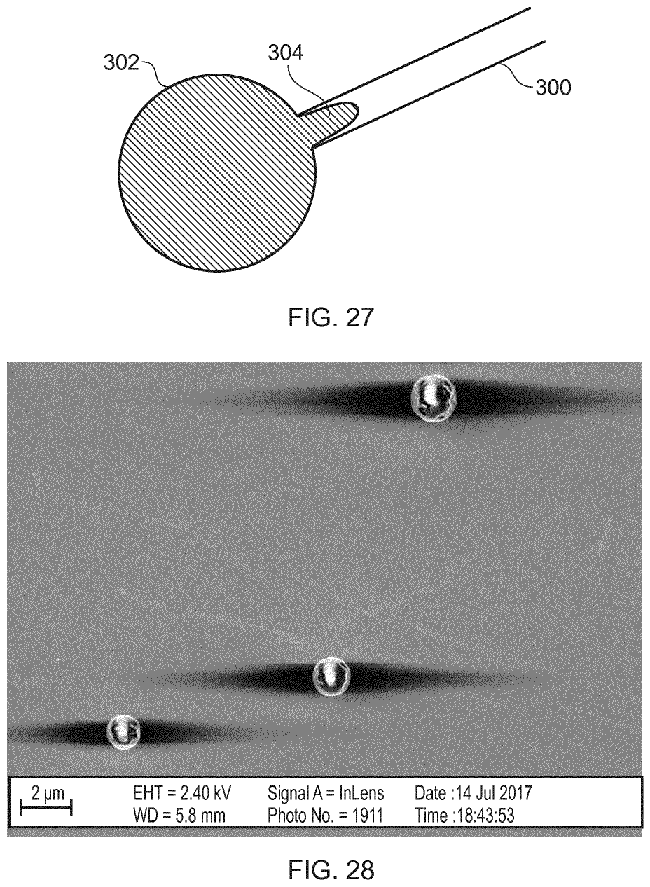

FIG. 27 shows a schematic illustration of the anchoring of a CNT 300 to a core particle 302 formed of an electrochemically active material Fe-Al-Li-O via an integral protrusion 304 of the core particle 302 extending into the CNT 300. Only one CNT is illustrated, but it will be understood that a typical CNTSU has many CNTs anchored to the core particle. FIGS. 10c and 10d show exemplary TEM micrographs of protrusions extending from the core particle into CNTs in CNTSU nanostructures. This should be considered in contrast to the situation where a core particle has heterogeneous catalyst particles disposed at the surface of the core particle and the CNTs grow from those catalyst particles. In that case, the catalyst particles are not integral with the core. The difference between these situations can be considered in relation to the electrochemically active material. In the preferred embodiment of the present invention, the core particle is formed of the electrochemically active material, including the integral protrusion.

The protrusion of the material of the core particle into the carbon nanotube itself has the effect of increasing the contact area between the carbon nanotube and the active material. For example, the protrusion may protrude into the carbon nanotube for a distance which is greater than the internal diameter of the carbon nanotube. Considering another example, the protrusion may have an aspect ratio of protrusion length (along the principal axis of the carbon nanotube) to diameter (perpendicular to the principal axis of the carbon nanotube) of greater than 1, more preferably greater than 1.5. In some embodiments, this aspect ratio may be greater than 2, greater than 5 or even greater than 10.

The protrusion of the material of the core particle into the carbon nanotube is found to enable enhanced electricity conduction between carbon nanotube and active material of the core particle. It is considered that this is due to a reduction of interfacial resistance compared to the case where active material and carbon nanotube are connected via a foreign intermediate (e.g. a catalyst particle), which introduces an extra interfacial resistance, which is large because the surface area of the connection is small. Achieving a reduced interfacial resistance is considered to be a key point for improved battery performance.

The protrusion of the material of the core particle into the carbon nanotube is found to provide enhanced heat conduction between the carbon nanotube and the active material of the core particles. Similar reasons for this apply as for electrical conduction described above. This feature also is considered to be key to battery performance.

The protrusion of the material of the core particle into the carbon nanotube is found to lead to enhanced mechanical integrity of the overall structure, for similar reasons as described above. This is again considered to be key to battery performance, especially with conversion materials that have large volume expansion upon cycling. Additionally, this is considered to assist in maintaining the integrity of the sea-urchin structure during battery manufacturing, which typically involve high shear mixing/pestle and mortar of a sea urchin slurry.

As explained above, a particular preferred application for the CNTSUs is in the fabrication of lithium-ion battery electrodes. In such an application, the CNTSUs are arranged as an assembly, either as a film or layer deposited on a substrate.

The material reported here outperforms existing lithium-ion battery anode materials for a number of reasons:
Its capacity at low current is two times higher than that of graphite, the current standard for commercial Li-ion battery anodes.
It maintains a large capacity at high discharge rates, which is a requirement for the next generation of electrical vehicles.
The performances of the material do not degrade significantly over charge and discharge cycles.
The material facilitates battery thermal management, which is key to answering the safety issues that currently limit the development of the lithium-ion battery technology.
The material can be synthesised from inexpensive, widely available chemical precursors, using a continuous gasphase process that can be scaled-up industrially (similar processes are routinely used to produce the majority of commercially available nanomaterials in the world). Once synthesised it can easily be integrated to the existing assembly chains in standard lithium-ion battery factories.

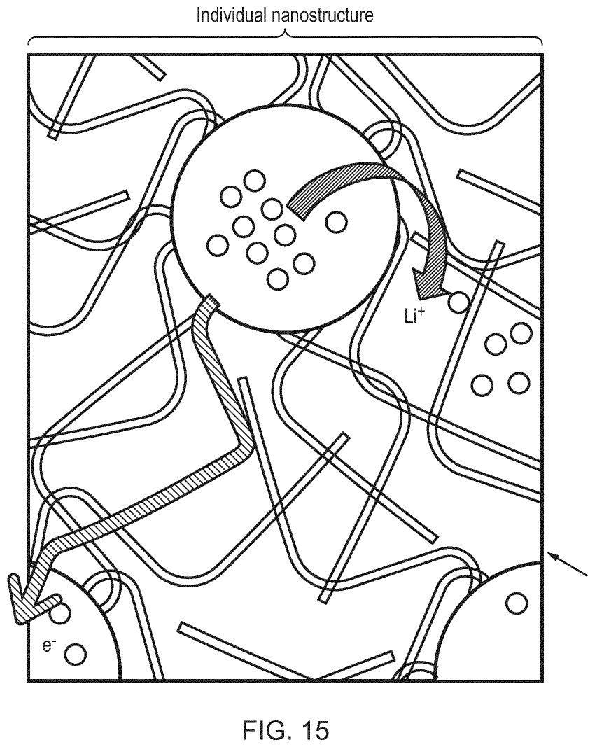

Referring now to FIGS. 14, 15 and 16A, the principle of operation is that lithium ions are stored in the metal oxide cores, while electrons and heat are conducted out via the carbon nanotubes. The hierarchical nature of the material over many length scales, coupled with the inherent chemical, mechanical, electrical, and thermal properties of the nanostructures enable high performances. In practice, the commercial product can be a powder to be coated on standard battery current collectors during battery assembly in factories.

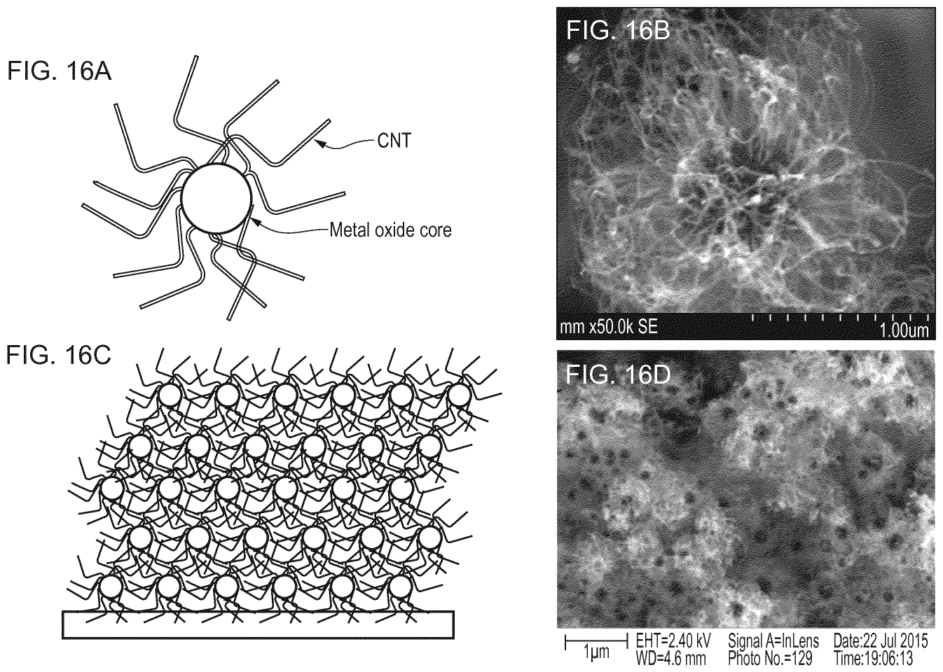

In a lithium ion battery as shown schematically in FIG. 14, the anode is the electrode that stores lithium ions during charge and expels them during discharge. This flow of positive charges between the anode and the cathode has to be matched by a flow of electrons, which produces useful work through an external circuit. In standard commercially available Li-ion batteries, the anode is composed of a graphite powder that acts as a host material for lithium ions, coated on a current collector (metal foil) with a polymeric binder that maintains the mechanical integrity of the electrode. In a preferred embodiment of the present invention, graphite is replaced by a film of metal oxide-carbon nanotube nanostructures as shown in FIG. 16C. The film can be coated on a current collector.

Within the realm of lithium-ion batteries, the current technology that is set to dominate the market for another ten years at least, these performances are primarily determined by the choice of the active material for the cathode and anode. The current challenge is to find materials that largely exceed the energy density and rate performances of commercially available batteries, without sacrificing the other performance parameters.

The material is an assembly of individual carbon nanotube-metal oxide nanostructures (FIGS. 16A and 16B) as a film on a current collector (FIGS. 16C and 16D). As explained above, the nanostructure is composed of a metal oxide spherical core with a diameter between 30 nm and 10 μm, onto which a large number of single-wall and/or multiwall carbon nanotubes are anchored. The metal oxide core consists of an amorphous alloy of aluminium, iron, and oxygen matrix, into which small crystallites of the same composition are embedded. The alloy composition is not homogeneous. It is thought that the molar proportion of Al:Fe:O is about 2:1:4 at the surface of the core and varies gradually to about 1:2:4 at the center of the core. The overall molar proportion of Al:Fe:O is 1.5/1/4. Different proportions can be used for Li-ion battery applications with ease, and give similar or better electrochemical results. Carbon nanotubes are covalently anchored to the core and extend radially, creating a porous, electrically and thermally conducting shell of carbon nanotubes around it, whose thickness is between about 10 nm and 10 μm on average.

The nanostructured film thickness can range from less than one monolayer to several hundreds of micrometres. The packing density can be varied according to the deposition process, from a very porous film, to a highly compact one.

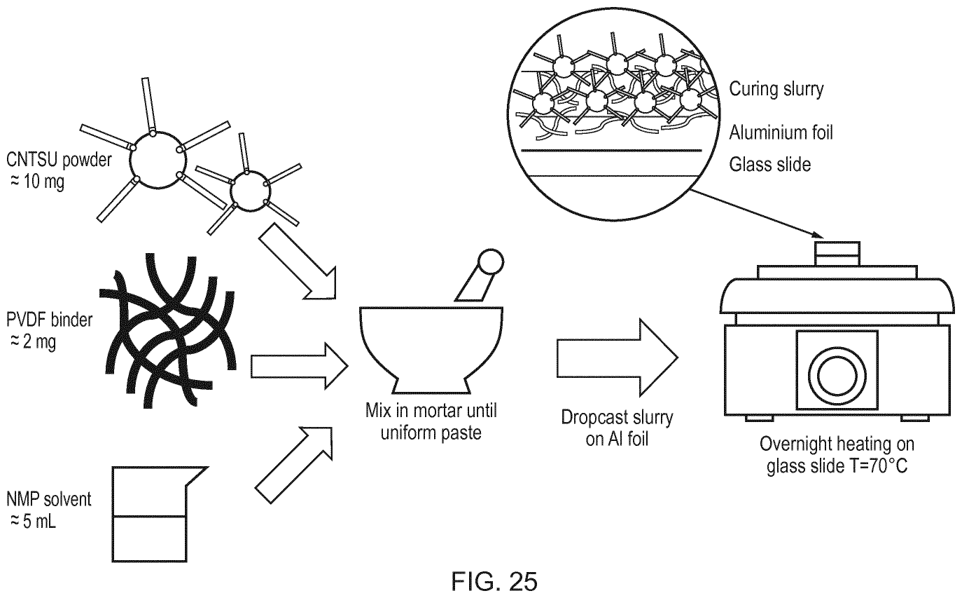

FIG. 25 illustrates a suitable lab-scale process for manufacturing an anode according to a preferred embodiment of the invention. CNTSU powder is manufactured as explained above. The CNTSU powder (10 mg) is mixed with PVDF binder (2 mg) and NMP solvent (5 mL) using a mortar until a uniform slurry is produced. The slurry is dropcast onto an Al foil, which is then heated at 70° C. overnight on a glass slide to provide the cured electrode.

In addition to the use as an anode material for lithium ion batteries, there are other uses for the material: active material for other electrochemical devices (alternative battery types, supercapacitors, fuel cells, electrochemical water filters, electrocatalysis, photocatalytic water splitting, etc.), filler additive for enhanced mechanical, thermal, and electrical properties of composites, or production of large area carbon nanotube mat or fibres for a number of applications (composites, actuators, heat sinks, electric cables, electromagnetic shielding, etc.).

In the context of lithium ion batteries, the present invention combines both material advantage and nanostructure engineering to design an anode structure that optimises ion diffusion, electron transport, mechanical stability and Li ion kinetics, as these are the most stringent conditions needing a balance in high energy/power batteries. One main problem impeding the commercialisation of metal oxide electrodes [Cabana et al (2010)] is voltage hysteresis associated with their charge/discharge cycles. This originates from multiple pathways of the conversion reactions between metal oxide and Li ions and complexities in phase transformation of active particles, resulting in unregulated reaction pathways during battery charge-discharge cycles. Thus, maintaining an uninterrupted ion/electron transport across electrodes together with a high mechanical resilience as battery is charged and discharged, remains a challenging task till to date.

Rationale Behind Our Metal Oxide-CNT Electrode Design

One way to mitigate poor ion/electron transport and electrode stability that causes capacity decay is to design electrodes that can couple the active particles (iron oxide) and conductive additive (carbon) at a single particle level with adequate control over particle morphology and carbon-metal oxide interface. In our urchin like structures (FeₓAl₁₋ₓO_{y}-MWCNT), the core is made of an alloy of Al-Fe-O that acts as active particles while CNTs play a dual role by acting as in situ conductive additive and mechanical spacer for active particles that typically tend to swell and disintegrate during charge-discharge cycles. The major advantages of our design are that (i) it in principle can offer high electrical accessibility of active particles for effective conversion reactions, during which the volume expansion of particles is efficiently accommodated by void space and the mechanical buffer effect of CNTs, (ii) the compaction of urchins in electrodes results in a porous network conducive to better electrolyte immersion, and (iii) CNTs are efficient heat dissipaters that can potentially avoid thermal runway of batteries.

Electrical Characterization

Method:

Swagelok-type coin cells were fabricated using standard procedures to test the performances of the invented material versus lithium metal (half cell configuration) and versus a common commercially available cathode material (full cell configuration). In both cases the CNTSU electrode was fabricated according to the steps shown in FIG. 25. These cells were then subjected to thorough electrochemical testing.

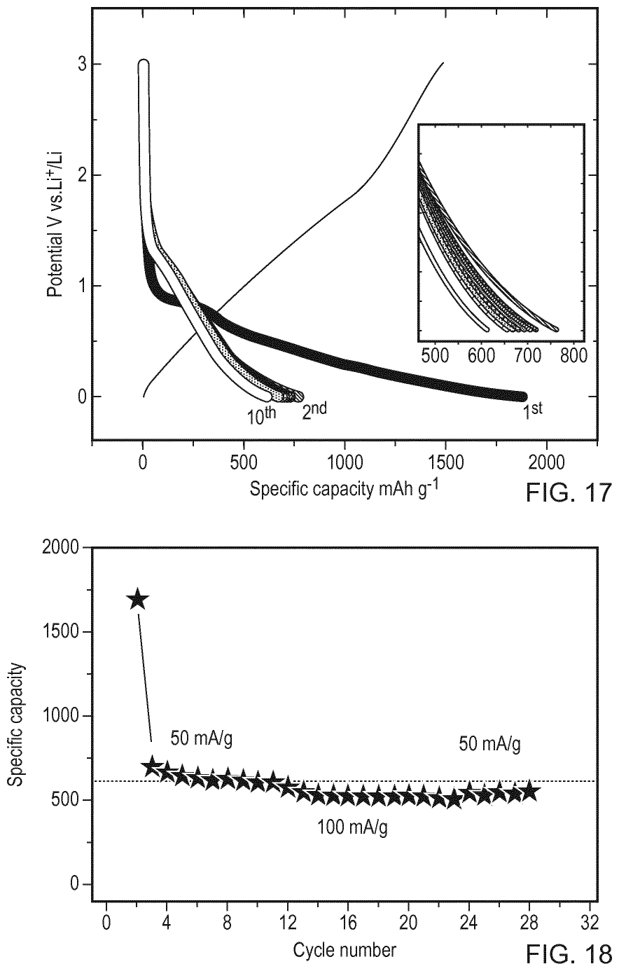

FIG. 17 reports the constant current charge-discharge profiles of FeₓAl₁₋ₓO_{y}-MWCNT urchins. The initial capacity reaches up to 1800 mAh·g⁻¹ and fades to one half but still delivers about 700 mAh/g as a reversible capacity. This capacity is threefold of the practical capacity of commercial graphite anodes [Wu et al (2003)]. The first-cycle capacity loss is typically attributed to the formation [Paolella et al (2013)] of passivation films (SEI) on urchins as a result of Li insertion. Although such loss is inevitable completely it can be minimised, for example, by pre-lithiation of active particles.

We found that the 2^{nd} cycle capacity was almost retained when the current density was doubled. FIG. 18 demonstrates the cyclability of urchin electrodes without undergoing a gradual capacity decay that most of FeₓO_{y} electrodes exhibit normally. This indicates the Li ion kinetics are not hampered by deleterious effects that conversion reactions impose on the interior microstructure of active particles such as the formation electrically inaccessible domains, particle pulverization and irreversible consumption of Li ions in SEI. This also highlights the presence of Al in FeₓO_{y} improves the electrode cycling stability.

We carried out cycling voltammetry (CV), which can give information on the actual electrodes processes (i.e. conversion reactions between urchins and Li⁺ ions that produce current/voltage). In FIG. 19 the broad peak at 1.0 V vs. Li/Li corresponds to the onset of Li ion insertion into urchins leading to a full conversion reaction and on the reverse the peak at 1.7 V indicates the decomposition of lithiated phases and oxidation of Fe. Overall, these results are comparable to recently reported FeₓO_{y} nanoparticle-graphene nanoribbon composite electrodes [Lin et al (2014)]. We note that the peak positions and their intensity in CV remained identical in successive cycles, which corroborate to the reversible capacity observed in cycling experiments (as in FIGS. 17 and 18).

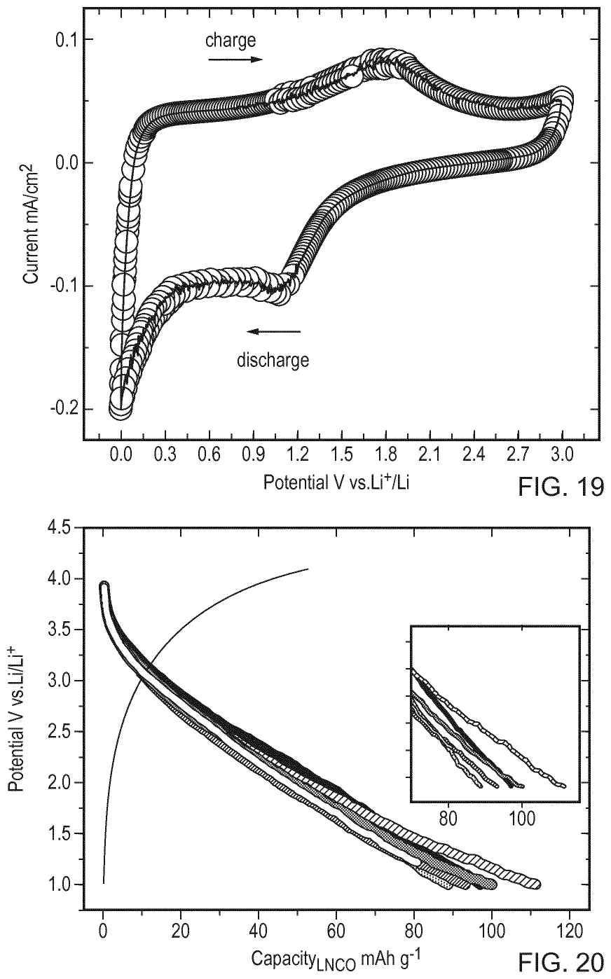

Lastly, we assembled full cells in which urchins served as anodes and LNCO (a commercial cathode material) served as cathodes. FIG. 20 reports the batteries operate around 3.1V with a sloping voltage plateau and deliver about 120 mAh/g at 50 mA/g (based on LNCO: theoretical capacity 160-190 mAh/g). This highlights the compatibility of our sea urchins as an anode with the commercial cathodes for fabricating full battery packages.

In conclusion of this section, sea urchin-like (FeₓAl₁₋ₓ O_{y})-MWCNT structures were tested in coin type half cells with Li metal and in full cells with lithium nickel cobalt oxide (Sigma-Aldrich). Urchin electrodes operate through a main voltage plateau around about 1V vs. Li⁺/Li which delivered a capacity of about 1800 mAh/g in the first cycle. Although this capacity was faded to almost 50% due to the commonly attributed SEI, it quickly stabilises in successive cycles yielding a reversible capacity (about 700 mAh/g) that is as twice as the capacity of the commercial graphite anodes. Constant current charge/discharge profiles show that urchin electrodes exhibit good cyclability and CV data confirm the reversible capacity.

It is possible therefore to produce anode electrode materials permitting the following performance:

Capacity: up to 2800 mAh·g⁻¹ (including 1^{st} cycle)
Rate (charge/discharge): upto 30 C (1 C=˜1000 mA/g)
Operation V Vs. Li⁺/Li: 1-3 V
Full cell voltage range vs. LNCO and vs. LiFePO₄: 1-4.2 V

In preferred embodiments, the full cell has the following construction:

Anode: as described above.
Cathode: LNCO (lithium nickel cobalt oxide) and LiFePO₄ (commercial), or NCA (lithium nickel cobalt aluminium oxide) or NMC (lithium nickel cobalt manganese oxide) or LCO (lithium cobalt oxide)
Electrolyte: LiFP₆ in polycarbonates and LiTFSI in polycarbonates (commercial)
Binder: PDF, carboxymethyl cellulose, binder-free
Separator: Poly propylene (Cell guard), Whatman glass microfiber (commercial), paper, ceramic

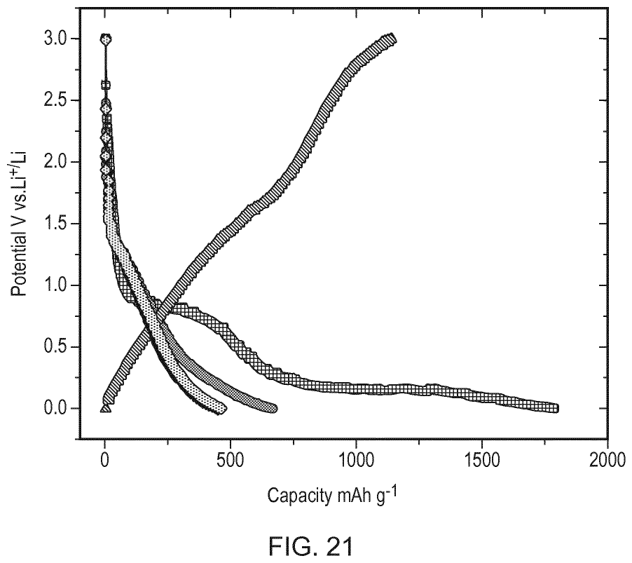

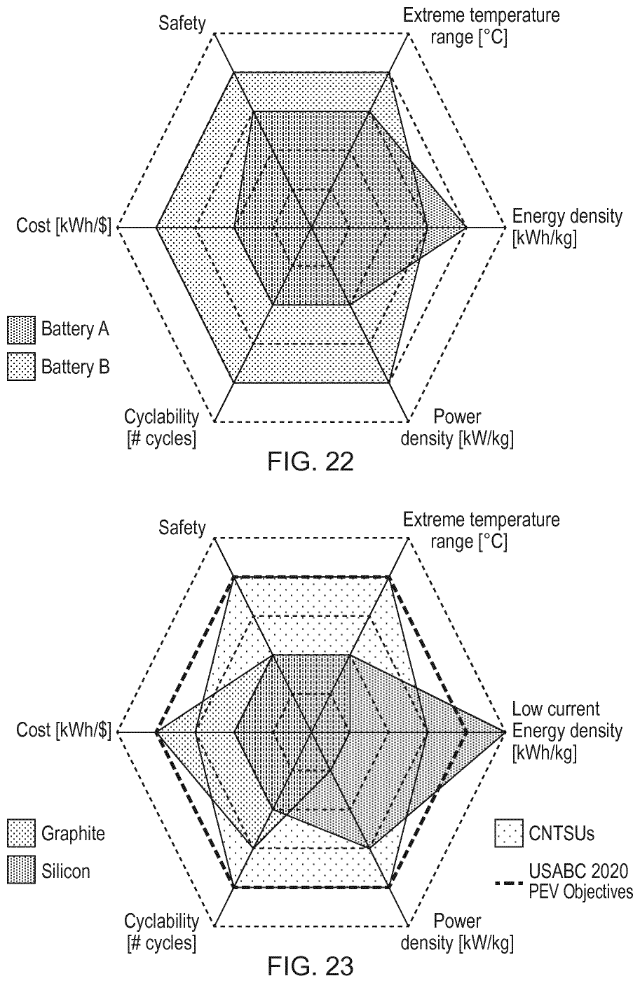

A control experiment was also carried out, in which the anode material consisted only the core particles (not the sea urchin structures) mixed with CNTs as conductive additive. FIG. 21 reports the charge/discharge profiles, demonstrating the electrochemical activities of the core particles themselves as an anode material for Li ion batteries. The cells delivered up to 1800 mAh·g⁻¹ and faded to more than half of the original capacity value. This capacity fade is typically attributed to the formation of SEI and loss of electrical connection between active cores and carbon additives as a result of conversion reactions.

The present inventors consider that the irreversible capacity loss in the first cycle, as shown in FIG. 17, can be addressed via pre-lithiation of the material of the core particles. In order to benchmark an embodiment of the invention against the USABC 2020 goals in terms of energy and power density it is necessary to fabricate a full cell. The results reported here indicate that it is possible to reach performances that match nanoscale silicon energy density with higher power density, safety, and lifetime.

In terms of the scaled-up costs for the battery manufacture, the fact that CNTSUs can be synthesised via an aerosol process is a definite cost advantage.

Safety and extreme temperature range have not been measured at the time of writing, but in principle this should be better than graphite and silicon anodes owing to the fundamental nature of conversion reactions taking place in the core particles.

Overall, based on our experimental data and our understanding of the behaviour of conversion-type active materials, one can expect the current performances of our CNTSU material to be as depicted in FIG. 23. Note that this drawing is not intended to be quantitative, but rather it is a qualitative way to compare our material to existing technologies. We expect that, given some degree of further optimisation, our material will perform better than the best silicon anodes in all performance metrics except for the energy density. This will enabling the fabrication of batteries that reach or are close to reaching the USABC 2020 PEV (Plug-in Electric Vehicle) objectives. The energy density of Si only exceeds the CNTSU at low currents, but Si batteries have limited lifetime.

The present inventors have carried out further investigations into the spray-combustion process for forming the core particles, and the characterisation of CNTSUs formed using such as process, leading to further developments from the process schematically illustrated in FIG. 26. The core particles formed in this process have diameter in the range 1-5 μm, as opposed to 50 nm to 1 μm in the process described above and with reference to FIG. 1D. Furthermore, most of the core particles are found to be hollow, as evidenced by SEM.

For stage 1 of the process (spray drying), a commercial lab scale spray-dryer was used to spray-dry aqueous solutions of metal nitrates and maltodextrin (rather than sucrose) and to collect a dry powder of the same material. Briefly, the liquid feed is atomized into a drying chamber with a flow of hot nitrogen where droplets dry to form solid metal nitrate microparticles. Particles are then continuously entrained into a cyclone where they are collected into a vial. Nitrogen gas is then filtered and dried by a condenser, re-heated in a heat exchanger, and recirculated to the atomizer. A small amount of gas is bled-off to an exhaust and replaced with fresh nitrogen from a compressed gas bottle. At the end of the run (about 15 minutes), the spray-drier is stopped and the powder collected.

Operating parameters were as follows:
Inlet pressure 1.5-2 bar
Inlet temperature 200-220° C.

This resulted in a nitrogen flowrate of about 50 sL/min
Liquid federate: about 0.5 Uh

This resulted in an exhaust temperature of about 110° C.

The liquid feed composition was as follows:
Water
Iron nitrate (about 15 wt. %)
Aluminium nitrate (about 15 wt. %)
Maltodextrin (DE 16-18)—about 8 wt. %

In other embodiments, nitrates are replaced by citrates, and/or maltodextrin is replaced by sucrose.

The small amount of water soluble carbon precursor (e.g. maltodextrin) was added to the feed solution with the effect of reducing the hygroscopicity of the dried particles.

For stage 2 of the process (combustion), 300 mg of spray-dried powder was loaded in a ceramic boat, placed in a tube furnace set at T=300° C. with a 1 L/min flowrate of nitrogen gas at atmospheric pressure for 2 hours.

For stage 3 of the process (growing CNTs), 200 mg of the combusted powder was loaded in a ceramic boat, placed in a tube furnace where CNT growth by CVD is performed at T=750° C. Typical CVD growth parameters were:
Anneal with 100 sccm helium, 400 sccm hydrogen for 20 min
CNT growth for 1 min, with 400 sccm helium, 200 sccm hydrogen, 100 sccm ethylene
400 sccm helium flush for 5 min

The resulting sea urchin powder was used as the active material in a Li ion coin cell and tested.

FIG. 28 shows an SEM image of spray-dried, un-combusted particles (after stage 1).

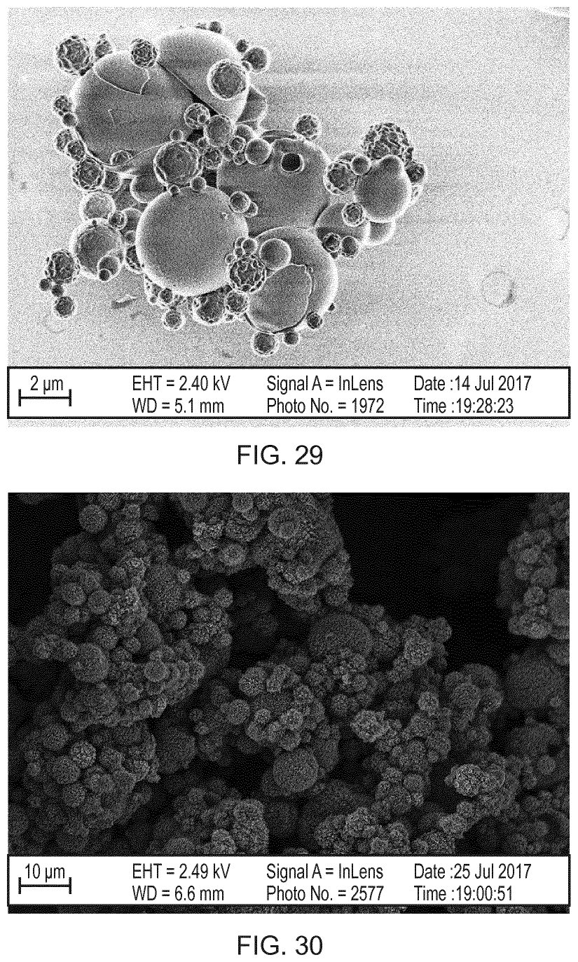

FIG. 29 shows an SEM image of combusted particles (after stage 2). Note that some particles are “broken” and/or hollow.

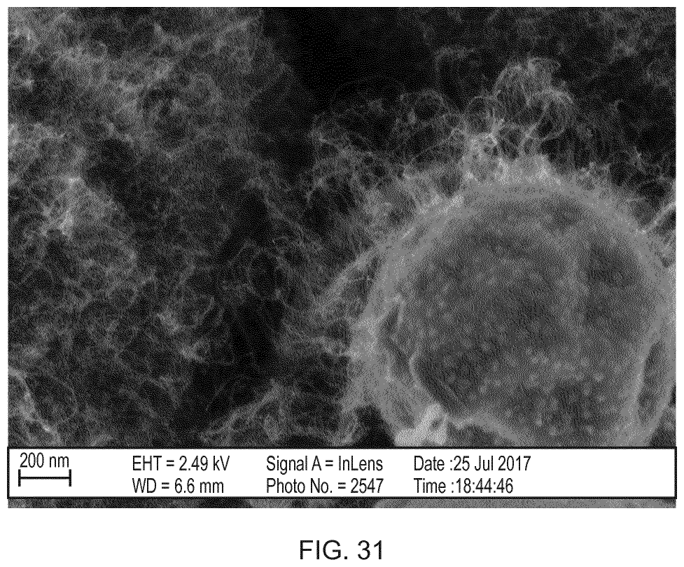

FIGS. 30 and 31 show SEM images at different magnifications of CNTSUs (after stage 3).

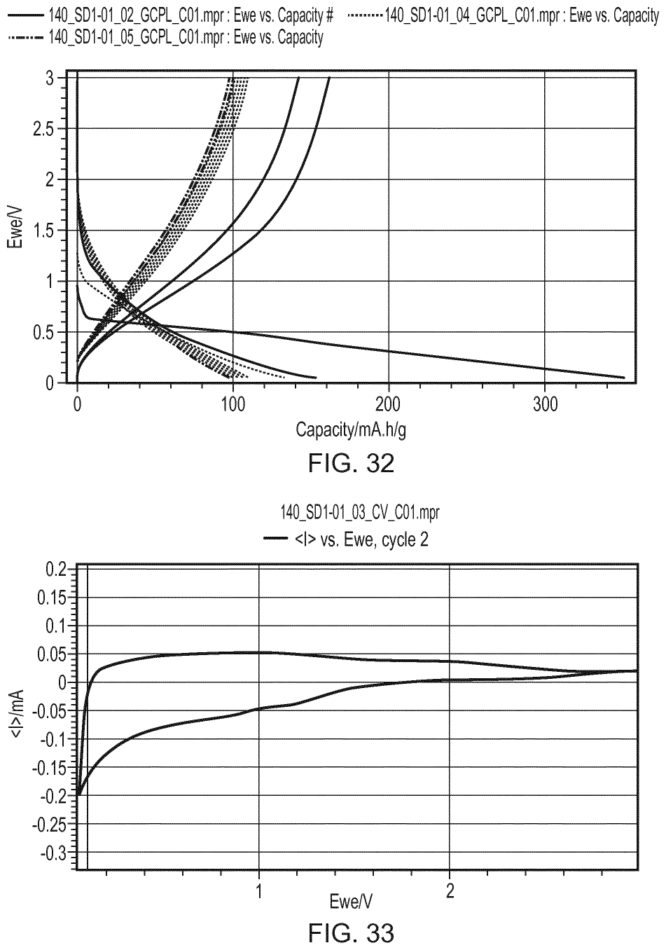

FIG. 32 shows the results of galvanostatic cycling, for a half cell configuration using the CNTSUs formed as described immediately above. FIG. 33 shows the results of cyclic voltammetry, for a half cell configuration using the CNTSUs formed as described immediately above.

In order to carry out electrochemical testing of sea-urchins with different Al-Fe-O ratios and with different CNT ratios, the core particles were produced using the spray combustion process and subsequently CNTSUs were produced as described above except that:
The ratio of iron nitrate to aluminium nitrate in the precursor solution was 4:1 as opposed to 1:1 previously, which result in a higher Fe/Al ratio in the core: Al/Fe=0.27 by moles.
After CNT growth, the particles were oxidised in air at 400° C. for 48 h, which resulted in a higher O content in the core compared to the experiment reported above. This was confirmed by a mass gain at 400° C. via TGA.
The CNT fraction of the CNTSUs was 8 wt % (compared with 40 wt % found for the process described above with reference to FIG. 1D).

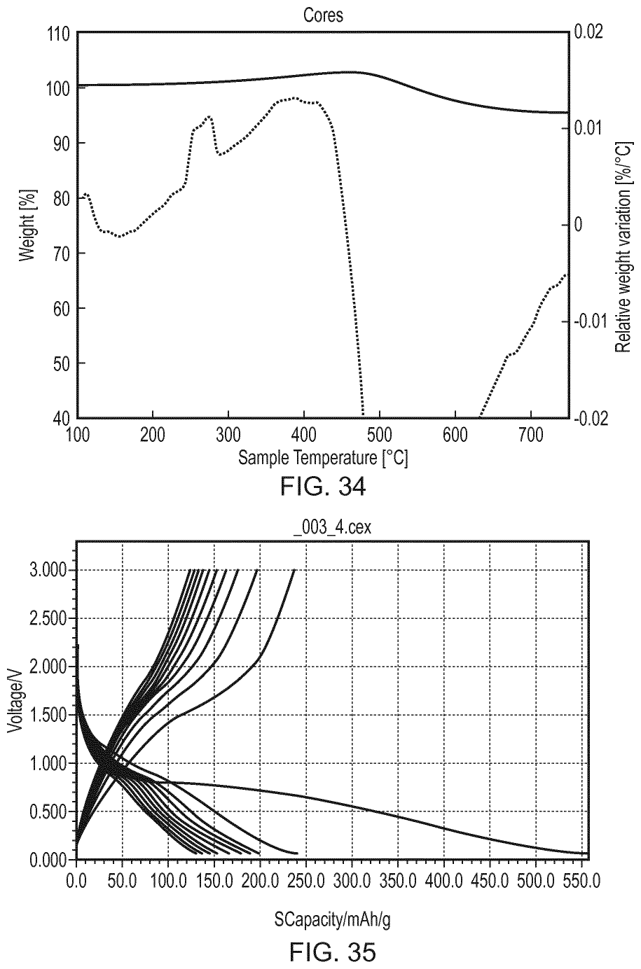

FIG. 34 shows the TGA results for the CNTSUs. The thick line shows the fraction of initial weight (left axis). The thin line shows relative weight variation rate (right axis [%/C]).

FIG. 35 shows the results of galvanostatic cycling, for a half cell configuration using the CNTSUs formed as described immediately above, with different Fe/Al ratio and different O content.

For comparison, sea-urchins with ZnFe₂O₄ cores and sea urchins with NCA cores were manufactured.

Commercially available ZnFe₂O₄ nanoparticle powder was purchased from Sigma Aldrich (<100 nm diameter characterised by BET). 200 mg of the powder was loaded in a ceramic crucible and CVD growth of CNTs was performed in the substrate-based growth CVD furnace as described above. After growth powder was collected and used as active material to be characterised in half cells.

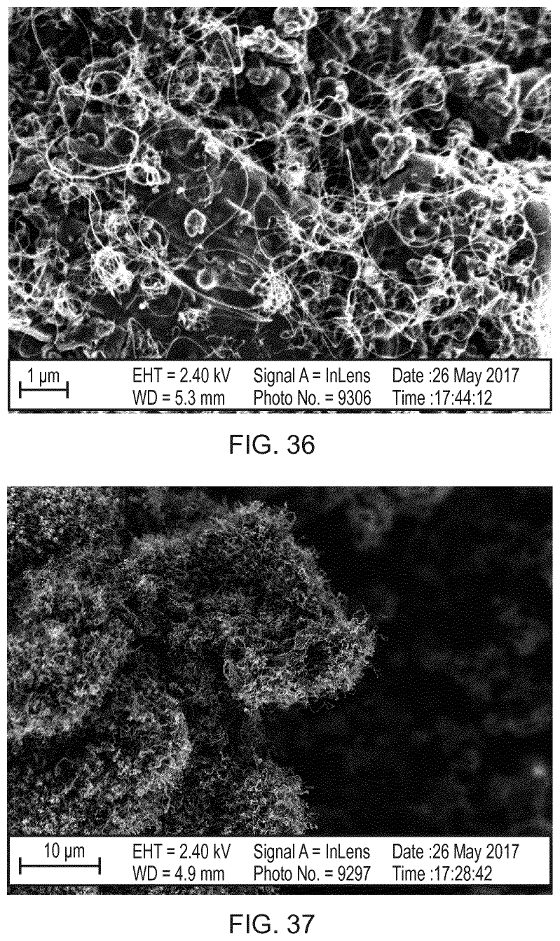

FIGS. 36 and 37 show SEM images of sea-urchins with ZnFe₂O₄ cores.

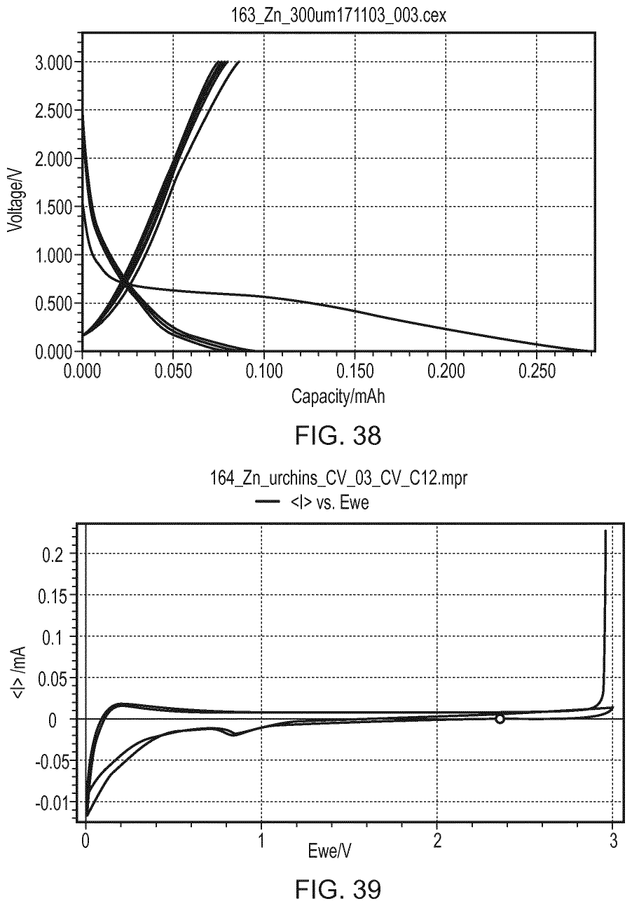

FIG. 38 shows the results of galvanostatic cycling, for a half cell configuration using the CNTSUs with ZnFe₂O₄ cores. FIG. 39 shows the results of cyclic voltammetry, for a half cell configuration using the CNTSUs with ZnFe₂O₄ cores.

For morphological comparison, of sea-urchins with NCA cores were manufactured. Commercially available Lithium Nickel Cobalt Aluminium Oxide (NCA) powder was purchased. 200 mg of the powder was loaded in a ceramic crucible and CVD growth of CNTs was performed in the substrate-based growth CVD furnace as described above.

Note that this material is a cathode material.

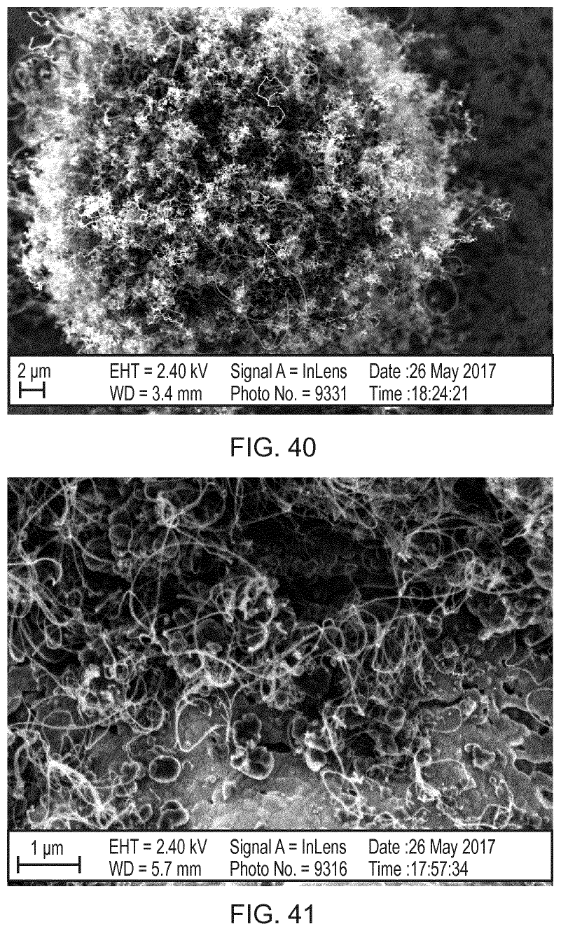

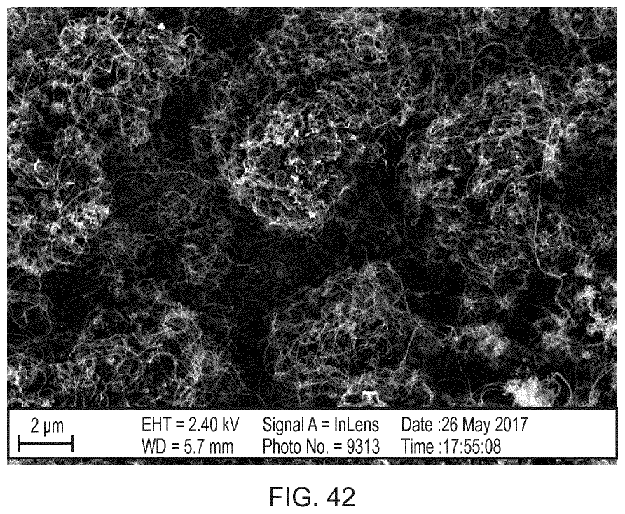

FIGS. 40, 41 and 42 show SEM images of sea-urchins with NCA cores.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above and/or below are hereby incorporated by reference.

### LIST OF NON-PATENT REFERENCES

Liu, N.; Lu, Z.; Zhao, J.; McDowell, M. T.; Lee, H.-W.; Zhao, W.; Cui, Y. Nat. Nanotechnol. 2014, 9 (3), 187-192.
Liang, X.; Hart, C.; Pang, Q.; Garsuch, A.; Weiss, T.; Nazar, L. F. Nat. Commun. 2015, 6, 5682.
Tuek, J.; Kemp, K. C.; Kim, K. S.; Zbo il, R. ACS Nano, 2014, 8, 7571-7612.
Cabana, J.; Monconduit, L.; Larcher, D.; Palacln, M. R. Adv. Mater. 2010, 22 (35).
Wu, Y. P.; Rahm, E.; Holze, R. J. Power Sources 2003, 114 (2), 228-236.
Paolella, A.; Brescia, R.; Prato, M.; Povia, M.; Marras, S.; De Trizio, L.; Falqui, A.; Manna, L.; George, C. ACS Appl. Mater. Interfaces 2013, 5 (7), 2745-2751.
Lin, J.; Raji, A. R. O.; Nan, K. W.; Peng, Z. W.; Yan, Z.; Samuel, E. L. G.; Natelson, D.; Tour, J. M. Adv. Funct. Mater. 2014, 24 (14), 2044-2048.
Han, Z. H., Yang, B., Kim, S. H., & Zachariah, M. R. (2007). Application of hybrid sphere/carbon nanotube particles in nanofluids. Nanotechnology, 18(10), 105701. doi:10.1088/0957-4484/18/10/105701
Kim, J. H., Ahn, J. Y., & Kim, S. H. (2014).Aerosol Synthesis and Optical Ignition of Sea Urchin-like Carbon Nanotube-Nanoenergetic Composite Materials (p. 2014).
Kim, S. H., Wang, C., & Zachariah, M. R. (2011). Aerosol formation of Sea-Urchin-like nanostructures of carbon nanotubes on bimetallic nanocomposite particles. Journal of Nanoparticle Research, 13(1), 139-146. doi:10.1007/s11051-010-0011-6
Park, S.-Y., Kim, W.-D., Kim, D.-G., Kim, J.-K., Jeong, Y.-S., Kim, J. H., . . . Kang, J.-W. (2010). Effect of hybrid carbon nanotubes-bimetallic composite particles on the performance of polymer solar cells. Solar Energy Materials and Solar Cells, 94(5), 750-754. doi:10.1016˜.solmat.2009.12.018
Ren, S., Zhao, X., Chen, R., Fichtner, M., Carbon-Nanofibers Encapsulated Metal Oxide Nanocomposite and Its Application as Conversion Anode Material for Lithium Ion Batteries, ECS Transactions, 64 (22) 155-164 (2015)
Glaize, C., & Genies, S. (2013). Lithium Batteries and Other Electrochemical Storage Systems. Wiley. doi:10.1002/9781118761120.ch9
Y.-L. Li, I. Kinloch, A. H. Windle, Direct spinning of carbon nanotube fibers from chemical vapor deposition synthesis., Science. 304 (2004) 276-278. doi:10.1126/science.1094982.
M. Han, W. Zhang, C. Gao, Y. Liang, Z. Xu, J. Zhu, J. He, Hollow nickel microspheres covered with oriented carbon nanotubes and its magnetic property, Carbon N. Y. 44 (2006) 211-215. doi:10.1016/j.carbon.2005.07.039.
Y. Piao, K. An, J. Kim, T. Yu, T. Hyeon, Sea urchin shaped carbon nanostructured materials: carbon nanotubes immobilized on hollow carbon spheres, J. Mater. Chem. 16 (2006) 2984. doi:10.1039/b601684g.
A. B. D. Nandiyanto, Y. Kaihatsu, F. Iskandar, K. Okuyama, Rapid synthesis of a BN/CNT composite particle via spray routes using ferrocene/ethanol as a catalyst/carbon source, Mater. Lett. 63 (2009) 1847-1850. doi:10.1016/j.matlet.2009.05.052.
D. He, M. Bozlar, M. Genestoux, J. Bai, Diameter- and length-dependent self-organizations of multi-walled carbon nanotubes on spherical alumina microparticles, Carbon N. Y. 48 (2010) 1159-1170. doi:10.1016/j.carbon.2009.11.039.
D. He, H. Li, W. Li, P. Haghi-Ashtiani, P. Lejay, J. Bai, Growth of carbon nanotubes in six orthogonal directions on spherical alumina microparticles, Carbon N. Y. 49 (2011) 2273-2286. doi:10.1016/j.carbon.2011.01.060.
F. S. Boi, G. Mountjoy, M. Baxendale, Boundary layer chemical vapor synthesis of self-organized radial filled-carbon-nanotube structures, Carbon N. Y. 64 (2013) 516-526. doi:10.1016/j.carbon.2013.08.001.
S. H. Kim, C. Wang, M. R. Zachariah, Aerosol formation of Sea-Urchin-like nanostructures of carbon nanotubes on bimetallic nanocomposite particles, J. Nanoparticle Res. 13 (2011) 139-146. doi:10.1007/s11051-010-0011-6.
W. D. Kim, J. Y. Ahn, D. G. Lee, H. W. Lee, S. W. Hong, H. S. Park, S. H. Kim, Tailoring the carbon nanostructures grown on the surface of Ni—Al bimetallic nanoparticles in the gas phase., J. Colloid Interface Sci. 362 (2011) 261-6. doi:10.1016/j.jcis.2011.06.043.
Z. H. Han, B. Yang, S. H. Kim, M. R. Zachariah, Application of hybrid sphere/carbon nanotube particles in nanofluids, Nanotechnology. 18 (2007) 105701. doi:10.1088/0957-4484/18/10/105701.
J. H. Kim, J. Y. Ahn, S. H. Kim, Aerosol Synthesis and Optical Ignition of Sea Urchin-like Carbon Nanotube-Nanoenergetic Composite Materials, in: 2014: p. 2014.
T. C. Lin, G. Seshadri, J A. Kelber, A consistent method for quantitative XPS peak analysis of thin oxide films on clean polycrystalline iron surfaces, Appl. Surf. Sci. 119 (1997) 83-92. doi:10.1016/S0169-4332(97)00167-0.
R. C. Flagan, Differential Mobility Analysis of Aerosols: A Tutorial, KONA Powder Part. J. 26 (2008) 254-268. doi:10.14356/kona.2008023.
J. S. Olfert, N. Collings, New method for particle mass classification—The Couette centrifugal particle mass analyzer, J. Aerosol Sci. 36 (2005) 1338-1352. doi:10.1016/j.jaerosci.2005.03.006.
B. Graves, J. Olfert, B. Patychuk, R. Dastanpour, S. Rogak, Characterization of Particulate Matter Morphology and Volatility from a Compression-Ignition Natural-Gas Direct-Injection Engine, Aerosol Sci. Technol. 49 (2015) 589-598. doi:10.1080/02786826.2015.1050482.
D. Gonzalez, A. G. Nasibulin, A. M. Baklanov, S. D. Shandakov, D. P. Brown, P. Queipo, E. I. Kauppinen, A New Thermophoretic Precipitator for Collection of Nanometer-Sized Aerosol Particles, Aerosol Sci. Technol. 39 (2005) 1064-1071. doi:10.1080/02786820500385569.
S. Ahmad, D. Copic, C. George, M. De Voider, Hierarchical Assemblies of Carbon Nanotubes for Ultraflexible Li-Ion Batteries, Adv. Mater. (2016) 1-6. doi:10.1002/adma.201600914.
A. C. Tumock, H. P. Eugster, Fe-Ai oxides: Phase relationships below 1000° C., J. Petrol. 3 (1962) 533-565.
R. J. Harrison, The temperature dependence of the cation distribution in synthetic hercynite (FeAl2O4) from in-situ neutron structure refinements, Am. Mineral. 83 (1998) 1092-1099.
G. Alan, C. Rodriguez, G. Garc, M. Isabel, M. Palma, K. Das Roy, A. Maria, G. Hemandez, Synthesis and Characterization of Hercynite Nanoparticles by Pulsed Laser Ablation in Liquid Technique, 43 (2015) 34-43. doi:10.1111/ijac.12212.
A. Velon, I. Olefjord, Oxidation Behavior of Ni3Al and Fe3A: I. XPS Calibrations of Pure Compounds and Quantification of the Results, Oxid. Met. 56 (2001) 415-424. doi:10.1023/a:1012589315800.
U. Golla-Schindler, Direct observation of spinodal decomposition in the magnetite-hercynite system by susceptibility measurements and transmission electron microscopy, Am. Mineral. 90 (2005) 1278-1283. doi:10.2138/am.2005.1849.
S. S. Lee, C. Zhang, Z. A. Lewicka, M. Cho, J. T. Mayo, W. W. Yu, R. H. Hauge, V. L. Colvin, Control over the diameter, length, and structure of carbon nanotube carpets using aluminum ferrite and iron oxide nanocrystals as catalyst precursors, J. Phys. Chem. C. 116 (2012) 10287-10295. doi:10.1021/jp212404j.
N. Loeffler, D. Bresser, S. Passerini, Secondary Lithium-Ion Battery Anodes: From First Commercial Batteries to Recent Research Activities, Johnson Matthey Technol. Rev. 59 (2015) 34-44. doi:10.1595/205651314X685824.
J. Cabana, L. Monconduit, D. Larcher, M. R. Palacin, Beyond intercalation-based Li-ion batteries: The state of the art and challenges of electrode materials reacting through conversion reactions, Adv. Mater. 22 (2010). doi:10.1002/adma.201000717.
N. J. Morales, S. Goyanes, C. Chiliotte, V. Bekeris, R. J. Candal, G. H. Rubiolo, One-step chemical vapor deposition synthesis of magnetic CNT-hercynite (FeAl2O4) hybrids with good aqueous colloidal stability, Carbon N. Y. 61 (2013) 515-524. doi:10.1016/j.carbon.2013.04.106.

1. An electrochemical device comprising an anode, cathode and electrolyte, wherein the anode and/or cathode comprises an active material comprising core particles and carbon nanotubes, the core particles are electrochemically active in the device and the carbon nanotubes are anchored on the core particles to form nanostructures.

2. An electrochemical device according to claim 1 wherein the carbon nanotubes are grown from the core particles.

3. An electrochemical device according to claim 1 wherein the carbon nanotubes are covalently bonded to the core.

4. An electrochemical device according to claim 1 wherein the core particles have protrusions extending from the core particle, the protrusions being formed integrally with the core particle, wherein respective protrusions protrude into respective carbon nanotubes to anchor the carbon nanotubes with respect to the core.

5. An electrochemical device according to claim 1 wherein the core particles have, on average, at least 10¹¹ carbon nanotubes per m² anchored on the core particles.

6. An electrochemical device according to claim 1 wherein the core particles have, on average, at most 10¹⁷ carbon nanotubes per m² anchored on the core particles.

7. An electrochemical device according to claim 1 wherein the material comprises at least 0.1 wt % by weight of carbon nanotubes, expressed in terms of the total weight of the core particles and the carbon nanotubes.

8. An electrochemical device according to claim 1 wherein the material comprises not more than 99% by weight of carbon nanotubes, expressed in terms of the total weight of the core particles and the carbon nanotubes.

9. An electrochemical device according to claim 1 wherein the core particles have a diameter in the range 30 nm to 50 μm.

10. An electrochemical device according to claim 1 wherein the particles have a diameter in the range 30 nm to 10 μm.

11. An anode active material for a lithium ion battery, the anode active material comprising particles of Fe-Al-Li-O, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe-Al-Li-O.

12. An anode active material according to claim 11 having an average discharge potential, when measured against Li/Li+ in a half cell, of at most 1.8 V.

13. An anode active material according to claim 11 wherein Al is present in an amount of at least 5 wt %.

14. An anode active material according to claim 11 wherein Al is present in an amount of at most 70 wt %.

15. An anode active material according to claim 11 wherein Li is present in the particles of Fe-Al-Li-O in an amount of at least 0.1 wt %.

16. An anode active material according to claim 11 wherein the particles contain lithium oxide and metallic iron.

17. An anode active material according to claim 11 further comprising an electrically conductive additive.

18. An anode active material according to claim 17 wherein the electrically conductive additive comprises elemental carbon.

19. An anode active material according to claim 17 wherein the electrically conductive additive comprises carbon nanotubes.

20. An anode active material according to claim 19 wherein the particles of Fe-Al-Li-O are core particles and the carbon nanotubes are anchored at one end on the core particles to form nanostructures.

21. An anode active material according to claim 20 wherein the carbon nanotubes are grown from the core particles.

22. An anode active material according to claim 20 wherein the core particles have, on average, at least 10¹¹ carbon nanotubes per m² anchored on the core particles.

23. An anode active material according to claim 20 wherein the core particles have, on average, at most 10¹⁷ carbon nanotubes per m² anchored on the core particles.

24. An anode active material according to claim 19 wherein the material comprises at least 0.1 wt % by weight of carbon nanotubes, expressed in terms of the total weight of the core particles and the carbon nanotubes.

25. An anode active material according to claim 19 wherein the material comprises not more than 99% by weight of carbon nanotubes, expressed in terms of the total weight of the core particles and the carbon nanotubes.

26. An anode active material according to claim 11 wherein the particles have a diameter in the range 30 nm to 50 μm.

27. An anode active material according to claim 11 wherein the particles have a diameter in the range 30 nm to 10 μm.

28. An anode active material according to claim 11 wherein the particles include a matrix of amorphous Al-Fe-O.

29. An anode active material according to claim 28 wherein Al-Fe-O crystallites are embedded in the matrix of amorphous Al-Fe-O.

30. An anode active material according to claim 29 wherein the Al-Fe-O crystallites comprise a solid solution of hercynite into magnetite.

31. An anode active material according to claim 20 wherein the carbon nanotubes are attached to the core particles at Al-Fe-O crystallites.

32.-35. (canceled)

36. A layer of material comprising particles of Fe-Al-Li-O and carbon nanotubes, wherein Fe is present in an amount of at least 10 wt % to at most 90 wt %, Al is present in an amount of at least 0.1 wt % to at most 90 wt %, and Li is optionally present, in an amount of 0 wt % or higher, wherein wt % is expressed in terms of the total mass of the particles of Fe-Al-Li-O, wherein the particles of Fe-Al-Li-O are core particles and the carbon nanotubes are anchored at one end on the core particles to form nanostructures.

37. A layer of material according to claim 36 wherein the layer of material is capable of self support.

38. A layer of material according to claim 36 wherein the layer of material has a tensile strength, measured on the layer without the presence of a supporting substrate, of at least 1 MPa.

39.-45. (canceled)
